(19) United States
(12) Patent Application Publication
(10) Pub. No.: US 2017/0121186 A1
(43) Pub. Date: May 4, 2017

(54) ADSORPTIVE FILTER UNIT HAVING EXTENDED USEFUL CYCLE TIMES AND/OR AN EXTENDED SERVICE LIFE

(71) Applicant: Blücher GmbH, Erkrath (DE)

(72) Inventors: Sven FICHTNER, Premnitz (DE); Raik SCHÖNFELD, Hannover (DE); Jann-Michael GIEBELHAUSEN, Rathenow (DE); Christian SCHRAGE, Dresden (DE); Antje MODROW, Kiel (DE)

(21) Appl. No.: 15/303,660

(22) PCT Filed: Feb. 19, 2015
(86) PCT No.: PCT/EP2015/053495

§ 371 Date: Oct. 12, 2016

(30) Foreign Application Priority Data
Apr. 17, 2014 (DE) 10 2014 005 645.7
May 27, 2014 (DE) 10 2014 107 489.0

(51) Int. Cl. C02F 1/28; B01D 53/04; B01D 53/26

(52) U.S. Cl. CPC C02F 1/283; B01D 53/261; B01D 53/04; C02F 2303/20; B01D 2253/102; B01D 2257/80; B01D 2253/311; B01D 2253/34; B01D 2253/308; B01D 2253/304

(57) ABSTRACT

The invention relates to a method for preparing an adsorptive filter unit having extended useful cycle times and/or an extended service life, especially improved and/or greater resilience and/or resistance against biological contamination and/or biological fouling, in particular and adsorptive filter unit for treating and/or purifying a fluid medium.

### CROSS-REFERENCES TO RELATED APPLICATIONS

This application is a National Stage filing of International Application PCT/EP 2015/053495, filed Feb. 19, 2015, entitled ADSORPTIVE FILTER UNIT HAVING EXTENDED USEFUL CYCLE TIMES AND/OR AN EXTENDED SERVICE LIFE, claiming priority to German Application Nos. DE 10 2014 005 645.7 filed Apr. 17, 2014, and DE 10 2014 107 489.0 filed May 27, 2014. The subject application claims priority to PCT/EP 2015/053495, to DE 10 2014 005 645.7, and to DE 10 2014 107 489.0 and incorporates all by reference herein, in their entirety.

### BACKGROUND OF THE INVENTION

The present invention relates to the technical field of adsorptive filters and/or filtering units useful, for example, to treat/clean fluids/fluidic media (i.e., gaseous or liquid media), in particular water, for example in the treatment or regeneration of wastewater or tapwater.

The present invention more particularly relates specifically to methods of providing an adsorptive filtering unit having an extended in-service/on-stream life, in particular having improved/increased stability and resistance to biocontamination/biofouling, which comprise the step of endowing/equipping the filtering unit of the invention with at least one specific particulate adsorbent in the form of a spherical activated carbon.

The present invention additionally relates as such to an adsorptive filtering unit having an extended in-service/on-stream life, in particular having improved/increased stability and resistance to biocontamination/biofouling.

The present invention further relates to methods of extending the in-service/on-stream life of the adsorptive filtering unit of the present invention and also to methods of treating/cleaning a fluidic medium, preferably water (such as wastewater or else tapwater).

The present invention further also relates to methods of using a specific particulate adsorbent in the form of a spherical activated carbon to extend the in-service/on-stream life of an adsorptive filtering unit.

The present invention lastly also relates to methods of using the adsorptive filtering unit of the invention particularly to treat and clean a fluidic medium, preferably water, or for the removal of noxiants or for gas purification/regeneration or to regenerate/provide cleanroom atmospheres.

Various filtering systems/principles are deployed in the prior art for purposes of treating/cleaning fluidic media. The filtering systems in question are generally employed therein to purposely change the composition of the fluidic medium to be cleaned, primarily by seeking to remove undesired (noxiant) materials from the medium in a very selective manner. The (noxiant) materials to be removed are generally present in solid/dispersed form or in dissolved form in a liquid medium, such as water, and, for example, in the form of an aerosol/dust or else as a gas in a gaseous medium, such as air.

Mechanical/physically based filters are primarily used in the prior art in this context to remove particulate substances and/or solid materials from a fluid to be cleaned. In general, however, mechanical filtering systems often entail the disadvantage that the in-service/on-stream lives are relatively short and, what is more, essentially only an unselective removal is possible, in that the filtering systems in question are in principle incapable of removing dissolved (noxiant) materials from liquids, such as water, and/or gaseous (noxiant) materials from gases/air.

To remove specifically dissolved/dispersed (noxiant) materials, by contrast, physicochemically/chemically based filtering systems are also employed to an appreciable extent, examples being based on membrane filters (reverse osmosis, for example) or chemical filters by use of chemicals to initiate precipitation reactions or the like. However, chemical methods of treatment are often burdensome in terms of equipment requirements, while the use of specific precipitating chemicals often entails a certain potential danger for the environment.

The cleaning of liquids, such as water, for example in the regeneration of tapwater, may also involve the use of so-called membrane filter systems and/or membrane processes, such as nanofiltration and/or reverse osmosis, for which semipermeable membranes are employable. Even dissolved (noxiant) materials and/or ions are removable in this way from the medium to be cleaned. The disadvantage with this, however, is the sometimes minimal efficiency of such filtering systems, associated with a high loss rate in respect of the medium to be cleaned. In addition, with membrane filter systems there is often a problem with a lasting germ load, and that this leads to a curtailed in-service/on-stream life and to reduced filtering efficiency. The fact that the selectivity of the underlying membranes is sometimes low is a further disadvantage. In addition, resultant residues often have a severe toxic load, so their disposal represents a further problem.

In addition, prior art processes may involve an ozone and/or UV treatment, in particular to break down undesired (noxiant) materials in a photochemical manner. A further approach to reduce the level of undesired (noxiant) materials particularly in raw, untreated water in the prior art thus consists in employing oxidation processes to chemically decompose the compounds to be removed. Disadvantages in this context, however, are the often attendant high energy costs, the burdensome removal of residual ozone in the treated water and also the undesired formation of toxic metabolites/breakdown products due to decomposition of the (noxiant) materials in question.

It is additionally in general possible for the process of cleaning/treating liquid or gaseous media to also utilize sorptive, specifically adsorptive, filtering systems, which often enable efficient and highly selective cleaning of the underlying medium, particularly also with regard to so-called microimpurities, as indicated hereinbelow.

This is because the (noxiant) materials to be removed by use of adsorptive filtering systems from the medium to be regenerated, in particular water (as for example in the course of a process of wastewater treatment and/or the provision of tapwater and/or of ultrapure water), in particular from their dissolved state in the medium, are as such generally so-called microimpurities, interchangeably also known as trace materials and/or micropollutants. These include not only industrial chemicals and flame retardants but specifically also active pharmaceutical ingredients and/or human drugs, such as analgesics, hormonally active agents or the like, which are secreted in unchanged form or as conjugates/metabolites after chemical conversion in the human organism and as a consequence pass into the municipal wastewater for example. They further include certain industrial chemicals, such as plasticizers, in particular bisphenol A, x-ray contrast agents, surfactants, pesticides or the like. Substances of this type, even in small amounts, have a high drug and/or toxic potential and also a low level of biocompatibility/bio-tolerability. Further examples include dissolved organic compounds/carbons (DOC) which may equally be present in water as an impurity.

Owing to the high toxic potential, the persistence and the high bioaccumulation potential of the aforementioned noxiant/trace materials and also the increasing use of such substances, there is an urgent need for wastewater from private households, from industry as well as from medical facilities that is contaminated with such substances and for tapwater already contaminated with such substances, to be treated in an efficacious manner by means of durable filtering systems in order to reduce the corresponding noxiants, for example for already polluted tapwater to be treated in a water treatment works before being fed into the tapwater grid.

As noted, one approach to reducing the level of microimpurities in fluidic media, in particular water, is to remove the impurities from the water sorptively, in particular adsorptively, using adsorptive filtering materials. Activated carbon, zeolites, molecular sieves, metal and/or metal oxide particles and also ion exchange resins or the like are usable in this context for example. Materials of this type do generally lead to efficient removal of noxiants. Even conventional activated carbons in particular are used in this context to reduce the level of noxiants/microimpurities.

However, when adsorptive materials are used in filtering systems to clean fluidic media, such as water or air, there is an in-principle risk of a case of germ load/biocontamination/biofouling developing on the adsorbent, including in particular after the adsorbent has been in contact with moisture for a prolonged period. This is because the aforementioned adsorptive materials have a porous structure with a relatively highly textured surface and therefore in principle constitute a preferred site for colonization by microorganisms and/or biological germs, in particular when there is a correspondingly moist milieu, as is the case for example with aqueous media but also with moist airstreams (exhaled air, for example).

Excessive colonization particularly of the surface of the adsorptive material with microorganisms and/or biological germs is associated with the central disadvantage that the development of a biological film on the surface of the adsorptive material has not least the effect of reducing/blocking the access of the medium to be cleaned to the pore system of the adsorptive material, so the pore system of the activated carbon is only minimally accessible, if at all, for the noxiants/microimpurities to be adsorbed. This leads to a lasting reduction in the cleaning/filtering efficiency of the underlying filtering system, entailing a significant shortening of the in-service/on-stream lives of such systems.

An excessive germ load on the adsorptive material also entails the risk that in the service/use of the filter, microorganisms/germs will detach from the surface of the adsorbent and pass into the medium to be and/or already cleaned, possibly and regrettably resulting in the medium and/or filtrate becoming contaminated, which is problematical not least with regard to the regeneration of tapwater and/or the provision of ultrapure water.

This is just one reason why prior art filtering systems may require a frequent replacement of the adsorptive material and/or the deployment of corresponding new filtering systems, which is not only technically inconvenient but also costly.

DE 36 24 975 C2 relates in this context to a packed bed filter based on a (filtering) shaft packed with a granular bed material, the sidewalls of which are permeable to the medium to be filtered, wherein activated carbon per se is usable as bed material in this context. Specific measures to reduce the germ load on the filtering material are not envisaged, so the in-service/on-stream life of the filtering system is not always optimal.

DE 1 642 396 A1 further relates to a method of treating wastewater by first separating off suspended solids, treating the raw sieved water with a flocculant, separating the supernatant water from the resultant flocculation and passing the supernatant water through activated carbon beds. Conventional activated carbons are employed, but they will in some instances have an excessive proclivity to attract a germ load.

WO 2007/092914 A1 relates to a wastewater treatment system comprising a filtering element/vessel containing a natural/biobased filtering material and a further filtering material in the form of conventional activated carbon and also a wastewater inlet and a wastewater outlet. The use of conventional activated carbon in combination with a biobased filtering material will result in an occasionally excessive risk of a germ load developing on the filtering materials used, which is inimical to the proficiency of the filtering system.

An adsorptive material particularly in the form of activated carbon becoming biocontaminated with a germ load is also problematical for corresponding filtering applications to clean up gas phases, in particular when the gas/air streams to be cleaned have a high moisture content, since this may result in condensate forming in/on the adsorptive material, which will in turn lead to optimum growing conditions for germs/microorganisms. Reference in this connection must be made in particular to the use of activated carbon as an adsorptive material in respirator type filtering systems or fume extractor hoods or the like.

In this context, DE 38 13 564 A1 and EP 0 338 551 A2, which is a member of the same patent family, relate to an activated carbon filter layer for NBC respirators or the like that comprises a highly permeable, substantially shape-stable three-dimensional supporting scaffold whereto is fixed a layer of granular activated carbon corpuscles, wherein the supporting scaffold may comprise a braid from wires, monofilaments or struts and/or a foam-based structure. Activated carbon particles are used as such in this context, so a germ load may sometimes develop under unfavorable conditions, in particular since the filtering system in question is to be used in NBC respirators and hence may also come into contact with moistened air (air exhaled by the user).

Altogether, therefore, there is an immense need in the art for the provision of adsorptive filtering systems which when used to clean/treat fluidic media, such as water or gas (mixtures), have a reduced tendency to become biocontaminated with a germ load.

Against this background, therefore, it is an object of the present invention to provide an efficient concept for providing an adsorptive filtering unit having an extended in-service/on-stream life, in particular having improved/increased stability/resistance to biocontamination/biofouling, and/or a filtering unit as such while at least substantially avoiding or else at least attenuating the prior art disadvantages recounted above.

### BRIEF SUMMARY OF THE INVENTION

It is more particularly an object of the present invention to make available an adsorptive filtering unit, and/or a corresponding method of providing same, where the adsorptive filtering unit thus provided shall have an improved resistance/stability to biofouling and/or microbial contamination particularly under in-service conditions (i.e., in the use state for filtration of fluidic media) and where the adsorptive filtering unit provided according to the present invention shall equally have a high efficiency regarding the removal/adsorption of toxic substances, in particular in the form of microimpurities or the like, from a fluid to be cleaned up.

It is similarly yet a further object of the present invention to provide corresponding adsorptive filtering units which altogether have an extended in-service/on-stream life and which display a high level of suitability for filter applications, for example in the context of water regeneration, but also with regard to the reconditioning/treatment of airstreams.

The achieve the object recounted above, the present invention accordingly provides—in keeping with a first aspect of the present invention—a method of providing an adsorptive filtering unit having an extended in-service and/or on-stream life, in particular having improved and/or increased stability and/or resistance to biocontamination and/or biofouling, and in particular a method of providing an adsorptive filtering unit for treating and/or cleaning a fluidic medium, and/or in particular for adsorptive removal of inorganically or organically, in particular organically, based impurities, as described herein; further advantageous refinements and elaborations of this aspect of the invention form part of the subject matter of corresponding dependent and further independent method claims.

The present invention further provides—in keeping with a second aspect of the present invention—an adsorptive filtering unit as such having an extended in-service/on-stream life, as defined in the corresponding independent apparatus claim relating to the filtering unit of the invention; advantageous refinements and elaborations of the adsorptive filtering unit according to the invention form part of the subject matter of respective dependent and further independent apparatus claims.

The present invention yet further provides—in keeping with a third aspect of the present invention—a method of extending the in-service/on-stream life of an adsorptive filtering unit and/or a method of improving/increasing the stability/resistance of an adsorptive filtering unit to biocontamination/biofouling as per the method claim in this respect; further advantageous refinements and elaborations of the method according to the invention as per this aspect form part of the subject matter of corresponding dependent and further independent method claims.

The present invention also further provides—in keeping with a fourth aspect of the present invention—a method of treating/cleaning a fluidic medium, preferably water, such as wastewater or tapwater, as per the method claim in this regard; further advantageous refinements and elaborations of the method according to the invention as per this aspect form part of the subject matter of corresponding dependent and further independent method claims.

The present invention further provides—in keeping with a fifth aspect of the present invention—also a method of using a particulate adsorptive material in the form of a spherical activated carbon to extend the in-service/on-stream life of an adsorptive filtering unit as per the use claim in this regard and also a method of using the adsorptive material in question to treat/clean a fluidic medium, preferably water, such as wastewater or tapwater, as per the use claim in this regard.

The present invention finally further provides—in keeping with a sixth aspect of the present invention—the method of using the filtering unit of the present invention to treat/clean a fluidic medium and/or for the gas purification/regeneration or for the removal of noxiants and/or to regenerate or provide cleanroom atmospheres as per the independent use claims in this regard.

It will be readily understood that, in the hereinbelow following description of the present invention, such versions, embodiments, advantages, examples or the like, as are recited hereinbelow in respect of one aspect of the present invention only, for the avoidance of unnecessary repetition, self-evidently also apply mutatis mutandis to the other aspects of the present invention without the need for an express mention.

It will further be readily understood that any values, numbers and ranges recited hereinbelow shall not be construed as limiting the respective value, number and range recitations; a person skilled in the art will appreciate that in a particular case or for a particular use, departures from the recited ranges and particulars are possible without leaving the realm of the present invention.

In addition, any hereinbelow recited value/parameter particulars or the like can in principle be determined/quantified using standard/standardized or explicitly recited methods of determination or else using methods of determination/measurement which are per se familiar to a person skilled in the art.

As for the rest, any hereinbelow recited relative/percentage, specifically weight-based, recitations of quantity must be understood as having to be selected/combined by a person skilled in the art within the context of the present invention such that the sum total—including where applicable further components/ingredients, in particular as defined hereinbelow—must always add up to 100% or 100 wt %. However, this is self-evident to a person skilled in the art.

Having made that clear, the present invention will now be more particularly described.

### BRIEF DESCRIPTION OF THE DRAWINGS

FIG. 1 shows a graphic depiction of the water vapor adsorption behavior and/or the corresponding water vapor and/or adsorption isotherms of an activated carbon employed for the purposes of the present invention (solid triangles) and of a comparative carbon (solid squares).

FIG. 2A shows a scanning electron micrograph (SEM) image (plan view of an activated carbon corpuscle) of a polymer-based spherical activated carbon (PBSAC) employed for the purposes of the present invention; the picture shows the spherical shape and the smooth surface of the activated carbon employed for the purposes of the present invention.

FIG. 2B shows a schematic depiction of an activated carbon employed for the purposes of the present invention (a schematic depiction corresponding to FIG. 2A) to clarify the spherical shape and the smooth surface of the activated carbon employed for the purposes of the present invention.

FIG. 3A shows a scanning electron micrograph (SEM) image (plan view of an activated carbon corpuscle) of an activated carbon not employed in the context of the present invention, viz., a granulocarbon based on coconutshell; the picture shows the irregular/granular shape and the rough surface of the corresponding comparative carbon.

FIG. 3B shows a schematic depiction of an activated carbon not employed in the context of the present invention (a schematic depiction corresponding to FIG. 3A) to clarify the irregular, granular shape; the depiction clarifies the irregular shape and the high surface roughness of the corresponding comparative carbon.

FIG. 4 shows a graphic depiction in the form of a bar diagram of experimental results as per Example 2.

### DETAILED DESCRIPTION OF THE INVENTION

In a first aspect of the present invention, the present invention relates to a method of providing an adsorptive filtering unit having an extended in-service and/or on-stream life, in particular having improved and/or increased stability and/or resistance to biocontamination and/or biofouling, in particular an adsorptive filtering unit for treating and/or cleaning a fluidic medium, preferably water, more preferably wastewater or tapwater, and/or in particular for adsorptive removal of inorganically or organically, in particular organically, based impurities,

comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached.

It is thus a fundamental concept of the present invention for the method of providing the adsorptive filtering unit having an extended in-service/on-stream life in the manner of the present invention to utilize a very specific particulate adsorbent in the form of a spherical activated carbon, this activated carbon further having a specific total pore volume with a defined proportion of micro- and/or mesopores and having defined surficial properties with regard to its hydrophilicity, determined as water vapor adsorption behavior.

The water vapor adsorption behavior is determined in the context of the present invention on the basis of

DIN 66135-1, using water and/or water vapor as the underlying adsorptive and/or adsorbate. In this context, a static-volumetric method is used to determine the water vapor adsorption behavior at a temperature of 25° C. (298 kelvins). The determination of the hydrogen adsorption behavior is based on the pressure-dependent volume of adsorbed water/water vapor V_{ads}(STP) as determined at different/variable ambient pressures p/p₀ in the range from 0.0 to 1.0, where p₀ represents the pressure under standard conditions (1013.25 hPa). The water vapor adsorption behavior as invoked for the purposes of the present invention relates to the adsorption isotherms of the underlying activated carbon.

The water vapor adsorption behavior as specified above serves to provide a measure of the hydrophilicity/hydrophobicity of the activated carbon used for the purposes of the present invention, whereby the values indicated above are used as a basis for employing for the purposes of the present invention an activated carbon that on the whole is not very hydrophilic and so in common parlance can be referred to as hydrophobic.

More particularly, the activated carbons employed for the purposes of the present invention are relatively less hydrophilic than, for example, coconutshell- or pitch-based activated carbons and/or granulocarbons, which are altogether more hydrophilic and/or less hydrophobic than the activated carbon employed for the purposes of the present invention.

In this context, the activated carbons employed for the purposes of the present invention have in particular no significant water vapor adsorption below relatively high partial pressures p/p₀ since—without wishing to be tied to this theory—the activated carbons of the present invention have less affinity for polar water molecules owing to their lower hydrophilicity. Compared with the activated carbons of the present invention, a significant degree of water vapor adsorption takes place even at relatively low partial pressures p/p₀ with comparatively more hydrophilic activated carbons, such as the aforementioned activated and/or granulocarbons based particularly on coconutshells and/or pitch, this, as noted above, is precisely not the case in the present invention in respect of the activated carbon employed.

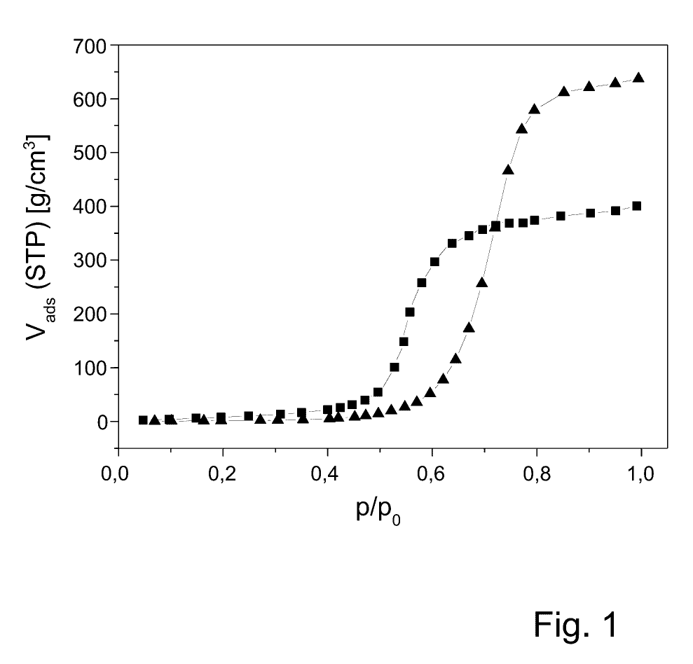

In this context, reference may also be made to the hereinbelow adduced FIG. 1, which shows the water vapor adsorption behavior of an activated carbon employed for the purposes of the present invention versus that of a different type of activated carbon, namely a granulocarbon based on coconutshells.

For further information and explanations regarding water vapor adsorption, reference may also be made to the (German-language) thesis of M. Neitsch, “Water Vapor and n-Butane Adsorption on Activated Carbon—Mechanism, Equilibrium and Dynamics of One Component and Conjoint Adsorption”, Faculty for Mechanical Engineering, Process Engineering and Energy Technology, Freiberg University of Mining and Technology, the entire content of which in this regard, in particular in regard of the explanations regarding adsorption of water and/or water vapor on activated carbons, is hereby fully incorporated herein by reference.

The present invention accordingly thus employs a very specific activated carbon that has a defined affinity for water, namely to the effect that what is employed for the purposes of the present invention is in particular an activated carbon of low hydrophilicity and/or a hydrophobic activated carbon, which activated carbon further comprises a defined total pore volume having an altogether high micro- and/or mesopore content.

This is because the applicant company found that, completely surprisingly, this is the way to efficiently reduce/prevent an activated carbon employed in filtration processes requiring a biological germ load/biocontamination/fouling with microorganisms under in-service/use conditions. What is further completely surprising in this connection is that the measures of the present invention—based on a defined affinity with respect to water, the above-defined total pore volume having a specific fraction of micro- and/or mesopores and also the use of activated carbon in spherical form—complement each other beyond the sum total of the individual measures and hence synergistically, which is also verified in that form by the working examples adduced for the purposes of the present invention.

More particularly and again without wishing to be tied to this theory, the defined pore volume and its defined pore sizes also have the effect that corresponding germs and/or microorganisms can only penetrate into the pores and/or the inner pore system to a reduced extent, if at all, which equally serves to reduce any fouling and/or germ load overall.

The applicant company further found that, completely surprisingly, the use of a very specific particulate adsorbent in the form of an activated carbon in the manner of the present invention whereby a spherical/ball-shaped activated carbon is employed in the invention in a purpose-directed manner, leads to a further reduction in germ load. Without wishing to be tied to this theory, the spherical/ball-shaped form of the activated carbon has the effect that, in the in-service/use scenario, an optimized/homogeneous flow of the fluidic medium to be cleaned through the filter material in the form of a multiplicity of activated carbon spherules, distinctly reducing the proportion of reduced-flow zones and/or so-called “dead” zones, which again serves to further prevent any accumulation/growth of microorganisms on the activated carbon.

Without wishing to be tied to this theory, the resistance of the activated carbon employed for the purposes of the present invention to biological germs and/or microorganisms is up in that germs are only able to colonize the activated carbon to a minor degree, if at all, resulting altogether in reduced (surface) growth on the activated carbon, entailing an improved accessibility to the pore system for the substances/noxiants to be adsorbed. By virtue of its specific surficial properties, growth conditions for germs/microorganisms on the activated carbon are nonoptimal, resulting in reduced growth/fouling even in the course of long in-service/on-stream periods.

The terms “biocontamination” and “biofouling” as used for the purposes of the present invention are to be understood as having very broad meanings and as relating in particular to germs/microorganisms growing on and/or colonizing the activated carbon employed as filter material, specifically on the surface of the activated carbon and possibly also in the activated carbon pore system bordering the surface. The germs/microorganisms in question are particularly aquatic and/or moisture-loving germs/microorganisms. The germs/microorganisms in question are particularly formed in a nonlimiting manner by single- and/or multi-cell, in particular single-cell, germs/microorganisms, examples being algae, bacteria, fungi, such as yeasts, protozoae or the like.

The term “spherical” used for the purposes of the invention is interchangeable with “ball shaped” and is further to be understood as having a very broad meaning and as relating particularly to an at least essentially ideal spherical/ball-shaped form of activated carbon, but also to such shapes and/or physical incarnations of the activated carbon employed which differ slightly from the sphere or ball shape, such as a configuration of the activated carbon in the form of a (rotational) ellipsoid or the like. The term “spherical” further also comprehends such spherical and/or ellipsoidal forms of activated carbon wherein the activated carbon may display, to a minor extent, bulges and/or indentations, dents, divets or the like without, however, the spherical shape being determinatively altered by this as a result. The invention is thus geared specifically to the use of a spherical activated carbon and/or of a spherocarbon and/or of a ball-shaped activated carbon.

Further to the method of the present invention, the activated carbon may have a hydrophilicity, determined as water vapor adsorption behavior, such that at a partial pressure p/p₀ of 0.6 not more than 25%, in particular not more than 20%, preferably not more than 10%, more preferably not more than 5%, of the maximum water vapor adsorption capacity of the activated carbon is exhausted and/or utilized. In particular, at a partial pressure p/p₀ of 0.6 not more than 25%, in particular not more than 20%, preferably not more than 10%, more preferably not more than 5%, of the maximum water vapor saturation loading of the activated carbon should be reached.

An embodiment preferred for the purposes of the present invention may further provide that the activated carbon has a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized. In particular, it may be provided for the purposes of the present invention that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor saturation loading of the activated carbon is reached.

Similarly, it may be provided for the purposes of the present invention that the activated carbon has a hydrophilicity, determined as water vapor adsorption behavior, such that at a partial pressure p/p₀ of 0.6 the activated carbon has adsorbed a water vapor quantity (H₂O volume) V_{ads(H2O)} which, based on the weight of the activated carbon, amounts to not more than 200 cm³/g, in particular to not more than 175 cm³/g, preferably to not more than 150 cm³/g, more preferably to not more than 100 cm³/g, yet more preferably to not more than 75 cm³/g.

In this connection, the activated carbon should have a hydrophilicity, determined as water vapor adsorption behavior, such that at a partial pressure p/p₀ of 0.6 the activated carbon has adsorbed a water vapor quantity (H₂O volume) V_{ads(H2O)} which, based on the weight of the activated carbon, is in the range from 10 cm³/g to 200 cm³/g, in particular 20 cm³/g to 175 cm³/g, preferably 30 cm³/g to 150 cm³/g, more preferably 40 cm³/g to 100 cm³/g, yet more preferably 50 cm³/g to 75 cm³/g.

In addition, the activated carbon should have a hydrophilicity, determined as water vapor adsorption behavior, such that in a partial pressure range p/p₀ of 0.1 to 0.6 not more than 25%, in particular not more than 20%, preferably not more than 10%, more preferably not more than 5%, of the maximum water vapor adsorption capacity of the activated carbon is exhausted and/or utilized. In particular, in a partial pressure range p/p₀ of 0.1 to 0.6 not more than 25%, in particular not more than 20%, preferably not more than 10%, more preferably not more than 5%, of the maximum water vapor saturation loading of the activated carbon should be reached.

It is further advantageous for the purposes of the present invention when the activated carbon has a hydrophilicity, determined as water vapor adsorption behavior, such that in a partial pressure range p/p₀ of 0.1 to 0.6 0.05% to 30%, in particular 0.1% to 25%, preferably 0.5% to 20%, more preferably 1% to 15%, yet more preferably 1% to 10%, of the maximum water vapor adsorption capacity of the activated carbon is exhausted and/or utilized. In particular, in a partial pressure range p/p₀ of 0.1 to 0.6 0.05% to 30%, in particular 0.1% to 25%, preferably 0.5% to 20%, more preferably 1% to 15%, yet more preferably 1% to 10%, of the maximum water vapor saturation loading of the activated carbon should be reached.

The above-adduced values of the water vapor adsorption behavior relate particularly to the underlying hydrogen adsorption isotherms of the activated carbon employed for the purposes of the present invention, as previously noted.

Further regarding the activated carbon employed in the context of the present invention, the applicant company similarly found that, completely surprisingly, the surface roughness of the activated carbon employed, determined as a fractal dimension of open porosity, also has a significant bearing on the resistance of the activated carbon to undesired colonization with germs/microorganisms. The fractal dimension of open porosity is a measure of said roughness, and therefore by general definition the closer the fractal dimension value to a value of 3, the rougher a material is. Correspondingly smaller values accordingly denote a lower roughness of the surface of the activated carbon. Without wishing to be tied to this theory, a low surface roughness leads to a reduced adherence/adhesion of germs/microorganisms to the underlying activated carbon, thereby further minimizing the fouling/germ load.

In this connection, it has been found to be particularly advantageous for the purposes of the present invention when the activated carbon has a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably not more than 2.75, yet even still more preferably not more than 2.7. In particular, the activated carbon employed for the purposes of the present invention should have a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7.

Further details for determining the fractal dimension of the activated carbon employed for the purposes of the present invention may be reviewed in the printed publications DE 102 54 241 A1, WO 2004/046033 A1, EP 1 562 855 B1 and also the same patent family's co-member equivalent US 2006/148645 A1, in particular in Example 4 of the respective printed publications. The respective content of the adduced printed publications is hereby fully incorporated herein by reference. As previously noted, the aforementioned fractal dimensions lead to further improved properties and/or resistance to any colonization with germs/microorganisms.

The fractal dimension of the activated carbon employed for the purposes of the present invention is determinable particularly by the method of Frenkel-Halsey-Hill (FHH method). Reference for this may be made for example to P. Pfeiffer, Y. J. Wu, M. W. Cole and J. Krim, Phys. Rev. Lett., 62, 1997 (1989) and to A. V. Neimark, Ads. Sci. Tech., 7, 210 (1991) and also to P. Pfeiffer, J. Kennter, and M. W. Cole, Fundamentals of Adsorption (Edited by A. B. Mersmann and S. E. Scholl), Engineering Foundation, New York, 689 (1991).

A particularly preferred embodiment of the present invention may additionally provide that the activated carbon employed for the purposes of the present invention has an ash content of not more than 1 wt %, in particular not more than 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon. In particular, the activated carbon in this context should have an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

This is because the applicant company similarly found in this context that, completely surprisingly, a reduced ash content similarly further reduces the fouling/colonization of the activated carbon with microorganisms. Without wishing to be tied to this theory, a reduced ash content on the part of the activated carbon employed also entails a reduced supply of nutrients, which reduces the growth of microorganisms/germs, in particular since growth conditions are not optimal for them. Ash content—again without wishing to be tied to this theory—is based particularly on such organobiological components as are metabolizable by microorganisms that colonize the activated carbon.

The activated carbon employed for the purposes of the present invention is further generally obtainable by carbonizing and then activating a synthetic and/or non-naturally based starting material, in particular based on organic polymers. This is because activated carbons are thereby providable that meet the requirements defined for the purposes of the present invention.

It has been found to be particularly advantageous in the context of the present invention to employ an activated carbon for the purposes of the present invention that is based on a very specific starting material. Therefore, in a particularly preferred embodiment, the activated carbon employed for the purposes of the present invention is obtainable from a starting material based on organic polymers, in particular based on sulfonated organic polymers, preferably based on divinylbenzene-crosslinked polystyrene, more preferably based on styrene-divinylbenzene copolymers, in particular by carbonizing and then activating the starting material.

This is because an activated carbon obtained on the basis of the starting materials adduced above has, firstly, a defined porosity, particularly also with regard to the pore distribution in respect of micro-, meso- and macropores, and also defined affinity properties with regard to water as per the above statements. In addition, an activated carbon of this type has a defined shape in a spherical configuration of the activated carbon. Further central advantages to an activated carbon of this type are that activated carbon based on organic polymers is very particularly free-flowing, abrasion-resistant and also dustless and hard, which is particularly advantageous for the concept of the present invention including as it relates to service in and/or as a water filter.

As far as the activated carbon employed with particular preference for the purposes of the present invention, obtained by carbonizing and then activating a starting material based on organic polymers, is concerned, the invention may provide that the divinylbenzene content of the starting material is in the range from 1 wt % to 20 wt %, in particular 1 wt % to 15 wt %, preferably 1.5 wt % to 12.5 wt %, more preferably 2 wt % to 10 wt %, based on the starting material.

The present invention may further provide in this context that the starting material is a specifically sulfonated and/or sulfo-containing ion exchange resin, in particular of the gel type.

The invention may provide in particular that the polymer-based spherical activated carbon (PBSAC) is used as activated carbon. More particularly, the activated carbon may be a polymer-based spherical activated carbon (PBSAC).

The activated carbon employed is in principle obtainable by known methods of the prior art. They more particularly comprise spherical sulfonated organic polymers, in particular on the basis of divinylbenzene-crosslinked polystyrene, being for this purpose carbonized and then activated to form the particular activated carbon, in particular as noted above. Further details in this regard may be reviewed for example in the printed publications DE 43 28 219 A1, DE 43 04 026 A1, DE 196 00 237 A1 and also EP 1 918 022 A1 and/or in the same patent family's co-member equivalent U.S. Pat. No. 7,737,038 B2, the respective content of which is hereby fully incorporated herein by reference.

Activated carbons employed in the context of the present invention are generally commercially available/obtainable. It is more particularly possible to employ activated carbons as marketed for example by Blucher GmbH, Erkrath, Germany, or by AdsorTech GmbH, Premnitz, Germany.

The parametric data recited hereinbelow with regard to the underlying activated carbon used/employed in the context of the present invention are determined by means of standardized or explicitly reported methods of determination or by using methods of determination which are per se familiar to a person skilled in the art. Especially the parametric data relating to the characterization of the porosity, of the pore size distribution and other adsorptive properties are generally each obtained from the corresponding nitrogen sorption isotherms of the particular activated carbon and/or the products measured. In addition, the pore distribution, particularly also with regard to the micropore content in relation to the total pore volume, is determinable on the basis of DIN 66315-1.

It has additionally been found advantageous in the context of the present invention when the activated carbon employed for the purposes of the present invention has a more specialized total pore volume, in particular a Gurvich total pore volume, as adduced hereinbelow.

Namely, the present invention may provide that the activated carbon has a total pore volume, in particular a Gurvich total pore volume, in the range from 0.3 cm³/g to 3.8 cm³/g, in particular 0.4 cm³/g to 3.5 cm³/g, preferably 0.5 cm³/g to 3 cm³/g, more preferably 0.6 cm³/g to 2.5 cm³/g, yet more preferably 0.7 cm³/g to 2 cm³/g.

The Gurvich determination of total pore volume is a method of measurement/determination which is well known per se to a person skilled in the art. For further details regarding the Gurvich determination of total pore volume, reference may be made for example to L. Gurvich (1915), J. Phys. Chem. Soc. Russ. 47, 805 and also to S. Lowell et al., Characterization of Porous Solids and Powders: Surface Area Pore Size and Density, Kluwer Academic Publishers, Article Technology Series, pages 111 ff. More particularly, the pore volume of activated carbon may be determined on the basis of the Gurvich rule as per the formula V_{P}=Wₐ/ρ₁, where Wₐ is the adsorbed quantity of an underlying adsorbate and ρ₁ is the density of the adsorbate employed (cf. also formula (8.20) as per page 111, chapter 8.4) of S. Lowell et al.).

The pore distribution of the activated carbon employed for the purposes of the present invention is also important for the concept which the present invention provides to reduce the germ load on the activated carbon in its service in the regeneration/filtering of a fluidic medium.

It may thus be provided in this connection that not less than 65%, in particular not less than 70%, preferably not less than 75%, more preferably not less than 80%, of the total pore volume, in particular of the Gurvich total pore volume, of the activated carbon is formed by pores having pore diameters of not more than 50 nm, in particular by micro- and/or mesopores.

More particularly, the present invention may provide that 60% to 90%, in particular 65% to 85%, preferably 70% to 80%, of the total pore volume, in particular of the Gurvich total pore volume, of the activated carbon is formed by pores having pore diameters of not more than 50 nm, in particular by micro- and/or mesopores.

It is further advantageous for the purposes of the present invention when 5% to 80%, in particular 10% to 70%, preferably 20% to 60%, of the total pore volume, in particular of the Gurvich total pore volume, of the activated carbon is formed by pores having pore diameters in the range from 2 nm to 50 nm, in particular by mesopores.

It may equally be provided according to the present invention that 1% to 60%, in particular 5% to 40%, preferably 10% to 35%, more preferably 15% to 33% of the total pore volume, in particular of the Gurvich total pore volume, of the activated carbon is formed by pores having pore diameters of more than 2 nm, in particular by meso- and/or macropores.

More particularly, the activated carbon may have a pore volume, in particular a carbon black micropore volume formed by pores having pore diameters of not more than 2 nm (i.e., ≦2 nm) in the range from 0.05 cm³/g to 2.1 cm³/g, in particular 0.15 cm³/g to 1.8 cm³/g, preferably 0.3 cm³/g to 1.4 cm³/g, more preferably 0.5 cm³/g to 1.2 cm³/g, yet more preferably 0.6 cm³/g to 1.1 cm³/g. In this context, 15% to 98%, in particular 25% to 95%, preferably 35% to 90% of the total pore volume of the activated carbon may be formed by pores having pore diameters of not more than 2 nm, in particular by micropores.

The carbon black method of determination is known per se to a person skilled in the art; moreover, for further details of the carbon black method of determining the pore surface area and the pore volume, reference may be made for example to R. W. Magee, Evaluation of the External Surface Area of Carbon Black by Nitrogen Adsorption, Presented at the Meeting of the Rubber Division of the American Chem. Soc., October 1994, as cited in, for example: Quantachrome Instruments, AUTOSORB-1, AS1 WinVersion 1.50, Operating Manual, OM, 05061, Quantachrome Instruments 2004, Florida, USA, pages 71 ff. More particularly, a t-plot may be used to analyze the data in this regard.

Without wishing to be tied to this theory, defining a pore size distribution for the activated carbon employed for the purposes of the present invention leads in the use scenario to a further reduction in germ load, in particular because, by virtue of the specific pore sizes, microorganisms cannot penetrate into the pore system of the activated carbon. In addition, the adsorption behavior of the activated carbon is further improved by the defined pore size distribution.

The activated carbon employed for the purposes of the present invention should further have a specific BET surface area in the range from 600 m²/g to 4000 m²/g, in particular 800 m²/g to 3500 m²/g, preferably 1000 m²/g to 3000 m²/g, more preferably 1200 m²/g to 2750 m²/g, yet more preferably 1300 m²/g to 2500 m²/g, yet still more preferably 1400 m²/g to 2250 m²/g.

The activated carbon may further have a surface area formed by pores having pore diameters of not more than 2 nm, in particular by micropores, that is in the range from 400 to 3500 m²/g, in particular 500 to 3000 m²/g, preferably 700 to 2500 m²/g, more preferably 700 to 2000 m²/g.

Similarly, the activated carbon may have a surface area formed by pores having pore diameters in the range from 2 nm to 50 nm, in particular by mesopores, that is in the range from 200 to 2000 m²/g, in particular 300 to 1900 m²/g, preferably 400 to 1800 m²/g, more preferably 500 to 1700 m²/g.

Determining the specific surface area as per BET is in principle known per se to a person skilled in the art, so no further details need be provided here in this regard. All BET surface areas reported/specified relate to the determination as per ASTM D6556-04. In the context of the present invention, the so-called Multi-Point BET method of determination (MP-BET) in a partial pressure range p/p₀ from 0.05 to 0.1 is used to determine the BET surface area in general and unless hereinbelow expressly stated otherwise.

In respect of further details regarding determination of the BET surface area and regarding the BET method, reference can be made to the aforementioned ASTM D6556-04 standard and also to Rompp Chemielexikon, 10th edition, Georg Thieme Verlag, Stuttgart/New York, headword: “BET-Methode”, including the references cited there, and to Winnacker-Kuchler (3^{rd} edition), volume 7, pages 93 ff. and also to Z. Anal. Chem. 238, pages 187 to 193 (1968).

It has been found to be particularly advantageous in the context of the present invention to employ a micro/mesoporous and/or a mesoporous activated carbon. This is because this provides a basis for addressing any significant germ load, in particular with regard to ensuring a degraded ability of microorganisms to penetrate into the pore system of the activated carbon. In addition, an activated carbon of this type leads to an even further optimized adsorption behavior, particularly also with regard to ensuring an appropriate rate of mass transfer inside as well as outside the activated carbon with regard to the medium to be cleaned. Therefore, the distribution of the pores, i.e., the proportion of micro-/meso- and/or macropores in relation to the total pore volume of the activated carbon is important; more particularly, porosity is precisely controllable/definable and thus custom-tailorable through the choice of the starting materials and also through the processing conditions.

In the context of the present invention, the term “micropores” refers to pores having pore diameters of less than 2 nm, whereas the term “mesopores” refers to pores having pore diameters in the range from 2 nm (i.e., 2 nm inclusive) up to 50 nm inclusive, and the term “macropores” refers to pores having pore diameters of more than 50 nm (i.e., >50 nm).

For the purposes of the present invention, the activated carbon should have an average pore diameter in the range from 0.5 nm to 55 nm, in particular 0.75 nm to 50 nm, preferably 1 nm to 45 nm, more preferably 1.5 nm to 35 nm, yet more preferably 1.75 nm to 25 nm, yet still more preferably 2 nm to 15 nm, yet even still more preferably 2.5 nm to 10 nm, most preferably 2.75 nm to 5 nm.

The average pore diameter may be determined from the quotient formed by dividing the BET surface area into four times the volume of a liquid adsorbed/taken up by the activated carbon (adsorbate) with completely filled pores (Vₜₒₜₐₗ) (pore diameter d=4·Vₜₒₜₐₗ/BET). For this, reference may be made to the corresponding explanations offered by R. W. Magee (loc. cit.), in particular to formula diagram (15) on page 71 of the cited reference.

It may further be provided according to the present invention that the activated carbon have a particle size, in particular a corpuscle diameter, in the range from 0.01 mm to 2.5 mm, in particular 0.02 mm to 2 mm, preferably 0.05 mm to 1.5 mm, more preferably 0.1 mm to 1.25 mm, yet more preferably 0.15 mm to 1 mm, yet still more preferably 0.2 mm to 0.8 mm. In particular in this context not less than 70 wt %, in particular not less than 80 wt %, preferably not less than 85 wt %, more preferably not less than 90 wt % of the activated carbon particles, yet more preferably not less than 95 wt %, of the activated carbon particles, especially activated carbon corpuscles may have particle sizes, in particular corpuscle diameters, in the aforementioned ranges.

In addition, the activated carbon may have a median particle size (D50), in particular a median corpuscle diameter (D50), in the range from 0.1 mm to 1.2 mm, in particular 0.15 mm to 1 mm, preferably 0.2 mm to 0.9 mm, more preferably 0.25 mm to 0.8 mm, yet more preferably 0.3 mm to 0.6 mm.

The corresponding corpuscle sizes/diameters are determinable on the basis of the ASTM D2862-97/04 method in particular. In addition, the aforementioned sizes are determinable with methods of determination which are based on sieve analysis, x-ray diffraction, laser diffractometry or the like. The particular methods of determination are as such well known to a person skilled in the art, so no further elaboration is needed in this regard.

The activated carbon employed for the purposes of the present invention may have a tapped and/or tamped density in the range from 150 g/l to 1800 g/l, in particular from 175 g/l to 1400 g/l, preferably 200 g/l to 900 g/l, more preferably 250 g/l to 800 g/l, yet more preferably 300 g/l to 750 g/l, yet still more preferably 350 g/l to 700 g/l. Tapped/tamped density can be determined as per DIN 53194.

The activated carbon may further have a bulk density in the range from 200 g/l to 1100 g/l, in particular from 300 g/l to 800 g/l, preferably 350 g/l to 650 g/l, more preferably 400 g/l to 595 g/l. Bulk density can be determined as per ASTM D527-93-00 in particular.

The activated carbon may further have a ball pan hardness and/or abrasion hardness of not less than 92%, in particular not less than 96%, preferably not less than 97%, more preferably not less than 98%, yet more preferably not less than 98.5%, yet still more preferably not less than 99%, yet still even more preferably not less than 99.5%. Therefore, the activated carbon employed for the purposes of the present invention is further notable for outstanding mechanical properties, which also manifests in the high level of ball pan hardness. The high mechanical strength of the activated carbon employed for the purposes of the present invention will lead to but minimal attrition in use, as is more particularly advantageous with regard to the in-service/on-stream life and also the avoidance of sludge formation due to attrition or the like particularly in the case of filter systems for regeneration of water. Ball pan hardness is generally quantifiable as per ASTM D3802-05.

The above-adduced high mechanical stability of the activated carbon employed for the purposes of the present invention is also reflected in a high compressive/bursting strength (weight-bearing capacity) per activated carbon grain. In this context, the activated carbon may have a compressive and/or bursting strength (weight-bearing capacity) per activated carbon grain, in particular per activated carbon spherule, of not less than 5 newtons, in particular not less than 10 newtons, preferably not less than 15 newtons, more preferably not less than 20 newtons. In particular, the activated carbon may have a compressive and/or bursting strength (weight-bearing capacity) per activated carbon grain, in particular per activated carbon spherule, in the range from 5 to 50 newtons, in particular 10 to 45 newtons, preferably 15 to 40 newtons.

Compressive/bursting strength may be determined in a manner known per se to a person skilled in the art, in particular by determining the compressive/bursting strength of individual particles/corpuscles via application of force with a ram until the respective particle/corpuscle bursts.

The activated carbon employed for the purposes of the present invention should as such (i.e., in its initial state and/or in the form of the starting material employed for the purposes of the present invention) additionally have a defined water/moisture content. Thus, the activated carbon may have a water and/or moisture content in the range from 0.05 wt % to 3 wt %, in particular 0.1 wt % to 2 wt %, preferably 0.15 wt % to 1.5 wt %, more preferably 0.175 wt % to 1 wt %, yet more preferably 0.2 wt % to 0.75 wt %, based on the activated carbon. The determination in this regard is made in particular in accordance with ASTM D2862-97/04.

A further property of significance with regard to reducing the colonization with microorganisms in the service scenario of the activated carbon employed for the purposes of the present invention is its wettability (determined under defined parameters/circumstances as adduced hereinbelow), in particular its water wettability. It has thus been found to be advantageous for the purposes of the present invention when the activated carbon employed for the purposes of the present invention has a wettability in particular water wettability, of not less than 35%, in particular not less than 40%, preferably not less than 45%, more preferably not less than 50%, yet more preferably not less than 55%. In addition, the activated carbon may have a wettability, in particular water wettability, in the range from 35% to 90%, in particular 40% to 85%, preferably 45% to 80%, more preferably 50% to 80%, yet more preferably 55% to 75%. For further information regarding determination of the wettability and/or water wettability, reference may be made to the hereinbelow adduced Example 1.

The activated carbon should further have an iodine number of not less than 1100 mg/g, in particular not less than 1200 mg/g, preferably not less than 1300 mg/g. In particular, the activated carbon should have an iodine number in the range from 1100 to 2000 mg/g, in particular 1200 to 1800 mg/g, preferably 1300 to 1600 mg/g. Iodine number is determined in particular in accordance with ASTM D4607-94/99.

The activated carbon employed for the purposes of the present invention may further have a butane adsorption of not less than 25%, in particular not less than 30%, preferably not less than 40%. In particular, the activated carbon may have a butane adsorption in the range from 25 to 80%, in particular 30 to 70%, preferably 35 to 65%. Butane adsorption can be determined in particular as per ASTM D5742-95/00.

The present invention as per the first aspect of the present invention similarly provides a method of providing an adsorptive filtering unit having an extended in-service and/or on-stream life, in particular having improved and/or increased stability and/or resistance to biocontamination and/or biofouling, in particular an adsorptive filtering unit for treating and/or cleaning a fluidic medium, preferably water, more preferably wastewater or tapwater, and/or in particular for adsorptive removal of inorganically or organically, in particular organically, based impurities, in particular as defined above,

comprising the step of endowing and/or equipping the filtering unit with at least one particulate adsorbent in the form of a spherical activated carbon, wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized, and/or wherein at a partial pressure p/p₀ of 0.6 0.1% to 30%, in particular 0.5% to 25%, preferably 1% to 20%, more preferably 1.5% to 15%, yet more preferably 2% to 10%, of the maximum water vapor saturation loading of the activated carbon is reached.

The present invention in the first aspect of the present invention further also provides a method of providing an adsorptive filtering unit having an extended in-service and/or on-stream life, in particular having improved and/or increased stability and/or resistance to biocontamination and/or biofouling, in particular an adsorptive filtering unit for treating and/or cleaning a fluidic medium, preferably water, more preferably wastewater or tapwater, and/or in particular for adsorptive removal of inorganically or organically, in particular organically, based impurities, in particular as defined above,

comprising the step of endowing and/or equipping the filtering unit with at least one particulate adsorbent in the form of a spherical activated carbon, wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a hydrophilicity, determined as water vapor adsorption behavior, such that at a partial pressure p/p₀ of 0.6 the activated carbon has adsorbed a water vapor quantity (H₂O volume) V_{ads (H2O)} which, based on the weight of the activated carbon, amounts to not more than 200 cm³/g, in particular to not more than 175 cm³/g, preferably to not more than 150 cm³/g, more preferably to not more than 100 cm³/g, yet more preferably to not more than 75 cm³/g.

The present invention in the first aspect of the present invention more particularly also provides a method of providing an adsorptive filtering unit having an extended in-service and/or on-stream life, in particular having improved and/or increased stability and/or resistance to biocontamination and/or biofouling, in particular an adsorptive filtering unit for treating and/or cleaning a fluidic medium, preferably water, more preferably wastewater or tapwater, and/or in particular for adsorptive removal of inorganically or organically, in particular organically, based impurities, in particular as defined above,

comprising the step of endowing and/or equipping the filtering unit with at least one particulate adsorbent in the form of a spherical activated carbon, wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably 2.75, yet even still more preferably 2.7, and/or wherein the activated carbon has a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7.

This is because, as noted above, the applicant company found that, completely surprisingly, the (surface) roughness—determined as fractal dimension of open porosity—of the activated carbon employed for the purposes of the present invention is also very significant for reducing the fouling/colonization of the surface with microorganisms/germs. More particularly—without wishing to be tied to this theory—microorganisms have a reduced ability to adhere to less rough and/or a smooth surface of the activated carbon material.

The present invention in the first aspect of the present invention finally also provides a method of providing an adsorptive filtering unit having an extended in-service and/or on-stream life, in particular having improved and/or increased stability and/or resistance to biocontamination and/or biofouling, in particular an adsorptive filtering unit for treating and/or cleaning a fluidic medium, preferably water, more preferably wastewater or tapwater, and/or in particular for adsorptive removal of inorganically or organically, in particular organically, based impurities, in particular as defined above,

comprising the step of endowing and/or equipping the filtering unit with at least one particulate adsorbent in the form of a spherical activated carbon, wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has an ash content of not more than 1 wt %, in particular not more than 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon, and/or wherein the activated carbon has an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

As noted above, a low ash content leads when the activated carbon is used/employed as filter material to reduced colonization with microorganisms, in particular since—without wishing to be tied to this theory—the food supply is reduced and hence the growth conditions for microorganisms are worse.

The present invention in a further aspect of the present invention further provides the adsorptive filtering unit of the present invention having an extended in-service and/or on-stream life, in particular having improved and/or increased stability and/or resistance to biocontamination and/or biofouling, in particular a filtering unit for treating and/or cleaning a fluidic medium, preferably water, more preferably wastewater or tapwater, and/or in particular for adsorptive removal of inorganically or organically, in particular organically, based impurities, obtainable according to the method of the present invention as defined/described above.

In this aspect of the present invention, the present invention thus more particularly provides an adsorptive filtering unit having an extended in-service and/or on-stream life, in particular having improved and/or increased stability and/or resistance to biocontamination and/or biofouling, in particular for treating and/or cleaning a fluidic medium, preferably water, more preferably wastewater or tapwater, and/or in particular for adsorptive removal of inorganically or organically, in particular organically, based impurities, wherein the filtering unit comprises at least one particulate adsorbent in the form of a spherical activated carbon, wherein the activated carbon has a total pore volume, in particular a Gurvich total pore volume, in the range from 0.15 cm³/g to 3.95 cm³/g, wherein not less than 60% of the total pore volume, in particular of the Gurvich total pore volume, of the activated carbon is formed by pores having pore diameters of not more than 50 nm, in particular by micro- and/or mesopores, and

wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached. The adsorptive filtering unit of the present invention is thus very useful for cleaning fluidic media, for example water or else air/gas mixtures, for which the adsorptive filtering unit of the present invention has by virtue of its use of a very specific particulate activated carbon an altogether improved in-service/on-stream life, particularly since the specific activated carbon employed has a significantly reduced germ load and/or degree of biofouling.

In this context, the activated carbon employed for the adsorptive filtering unit of the present invention should have a hydrophilicity, determined as water vapor adsorption behavior, such that at a partial pressure p/p₀ of 0.6 not more than 25%, in particular not more than 20%, preferably not more than 10%, more preferably not more than 5%, of the maximum water vapor adsorption capacity of the activated carbon is exhausted and/or utilized. In particular at a partial pressure p/p₀ of 0.6 not more than 25%, in particular not more than 20%, preferably not more than 10%, more preferably not more than 5%, of the maximum water vapor saturation loading of the activated carbon should be reached.

More particularly, the activated carbon should have a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized. In particular, at a partial pressure p/p₀ of 0.6 0.1% to 30%, in particular 0.5% to 25%, preferably 1% to 20%, more preferably 1.5% to 15%, yet more preferably 2% to 10%, of the maximum water vapor saturation loading of the activated carbon should be reached.

The adsorptive filtering unit provided according to the present invention as such preferably includes a multiplicity of spherical activated carbon particles which, as elaborated hereinbelow, may be present in the adsorptive filtering unit of the present invention in the form of a loose bed and/or fixed to a carrier.

The filtering unit of the present invention may furthermore comprise at least one carrier. It may in this case be provided according to the present invention that the particulate adsorbent in the form of the spherical activated carbon is self-supporting and/or in the form of a specifically loose bed. In this case, it is preferable for the purposes of the present invention when the carrier is configured in the form of a housing/casing specifically to accommodate the activated carbon. For this purpose, the housing should be at least essentially liquid impermeable, in particular water impermeable and/or gas impermeable, in particular air impermeable, and/or have appropriate inlet and/or outlet means for the fluidic medium to be cleaned.

However, in an alternative embodiment, the present invention may also provide that the particulate adsorbent in the form of the spherical activated carbon is mounted/fixed on the carrier and/or is in the form of a fixed bed. In this regard, the carrier may for example have a three-dimensional structure, for example in the form of a preferably open-cell foam, more preferably polyurethane foam. Similarly, however, the carrier may also have a two-dimensional and/or sheetlike structure. More particularly, the carrier may be configured as a preferably textile fabric.

When the activated carbon is mounted/fixed on the carrier, the carrier should be liquid permeable, in particular water permeable, and/or gas permeable, in particular air permeable, in particular in order to ensure that the medium to be cleaned may flow efficiently through the filtering unit and come into contact with the activated carbon in an optimum manner.

Particularly when the filtering element of the invention is employed as a gas/air filter, the carrier and/or the material constituting the carrier should have in particular a gas permeability, in particular air permeability, of not less than 10 l·m⁻²·s⁻¹, in particular not less than 30 l·m⁻²·s⁻¹, preferably not less than 50 l·m⁻²·s⁻¹, more preferably not less than 100 l·m⁻²·s⁻¹, yet more preferably not less than 500 l·m⁻²·s⁻¹, and/or a gas permeability, in particular air permeability, of up to 10 000 l·m⁻²·s⁻¹, in particular up to 20 000 l·m⁻²·s⁻¹, at a flow resistance of 127 Pa. In the case of filtering units/systems for cleaning fluidic media (particularly in the form of liquids, such as water), there should be corresponding permeabilities to the fluidic medium, in particular to water, in order to ensure corresponding (water) throughputs.

The carrier, in particular in the case of gas/air filters, may further be configured as a textile fabric, preferably an air-permeable textile material, preferably a woven, knitted, laid or bonded textile fabric, in particular a nonwoven fabric. In this context, the carrier or the carrier material may have a basis weight of 5 to 1000 g/m², in particular 10 to 500 g/m², preferably 25 to 450 g/m². In particular, the carrier may be a textile fabric containing or consisting of natural fibers and/or synthetic fibers (manufactured fibers). In particular here the natural fibers may be selected from the group of wool fibers and cotton fibers (CO). In addition, in this context, the synthetic fibers may be selected from the group of polyesters (PES); polyolefins, in particular polyethylene (PE) and/or polypropylene (PP); polyvinyl chlorides (CLF); polyvinylidene chlorides (CLF); acetates (CA); triacetates (CTA); acrylics (PAN); polyamides (PA), in particular aromatic, preferably flameproof polyamides; polyvinyl alcohols (PVAL); polyurethanes; polyvinyl esters; (meth)acrylates; polylactic acids (PLA); activated carbon; and also mixtures thereof.

This embodiment of the present invention may also provide in particular that the particulate adsorbent in the form of the spherical activated carbon is fixed to and/or on the carrier. This may in particular be via adherence, for example via an adhesive, or as a result of autoadhesion or of inherent tackiness.

When the activated carbon material is fixed to/on the carrier, it may be provided according to the present invention that the filtering unit of the present invention further has a casing. This casing is provided in particular for the case whereby the particulate adsorbent in the form of the spherical activated carbon is mounted on and/or fixed to the carrier and/or is employed in the form of a fixed bed using the carrier. In this context, the casing acts to externally confine the filtering unit of the present invention as well as to accommodate the carrier and the adsorbent. In this case, the casing should be liquid impermeable, in particular water impermeable, and/or gas/air impermeable. In general, the casing may have appropriate inlet and/or outlet means to apply and deliver, respectively, the fluidic medium, such as water or air, before and after cleaning, respectively.

According to the second aspect of the present invention, the present invention also provides an adsorptive filtering unit having an extended in-service and/or on-stream life, in particular having improved and/or increased stability and/or resistance to biocontamination and/or biofouling, in particular for treating and/or cleaning a fluidic medium, preferably water, more preferably wastewater or tapwater, and/or in particular for adsorptive removal of inorganically or organically, in particular organically, based impurities, in particular as defined above, wherein the filtering unit comprises at least one particulate adsorbent in the form of a spherical activated carbon, wherein the activated carbon has a total pore volume, in particular a Gurvich total pore volume, in the range from 0.15 cm³/g to 3.95 cm³/g, wherein not less than 60% of the total pore volume, in particular of the Gurvich total pore volume, of the activated carbon is formed by pores having pore diameters of not more than 50 nm, in particular by micro- and/or mesopores, and wherein the activated carbon has a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably 2.75, yet even still more preferably 2.7, and/or wherein the activated carbon has a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7.

In this context, the activated carbon employed for the present filtering element should have an ash content of not more than 1 wt %, in particular 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon. In particular, the activated carbon should have an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

Owing to its long in-service/on-stream life coupled with high filtering efficiency, the adsorptive filtering unit of the present invention is suitable for numerous uses in the area of gas/liquid regeneration. More particularly, owing to its lastingly reduced biofouling as compared with the prior art, the adsorptive filtering element of the present invention can also be considered for applications where an underlying medium has to be reconditioned/filtered to high purity, for example in the realm of tapwater regeneration and/or in the provision of ultrapure water or cleanroom atmospheres. This is because the significantly reduced biofouling means that correspondingly less by way of germs is released into the medium to be cleaned, and therefore the use of the filtering unit of the present invention is also capable of providing microbiologically high-purity media in the context of the present invention, and this even after long in-service/on-stream periods for the filtering unit of the present invention.

The filtering unit of the present invention may further be configured, in a nonlimiting manner, as a column filter particularly to clean fluidic media, such as water. Similarly, the filtering unit of the present invention may be configured as an air filter, for example for NBC respirators, fume extractor hoods or the like.

Preferred embodiments of the present invention will now be more particularly described with reference to illustrative drawings/figures, particularly also in a comparison with corresponding (comparative) embodiments that are not in accordance with the present invention.

Further advantages, properties, aspects and features of the present invention will also become apparent in connection with the description of these preferred embodiments of the present invention which, however, shall in no way limit the present invention.

In the illustrative figures,

FIG. 1 shows a graphic depiction of the water vapor adsorption behavior and/or the corresponding water vapor and/or adsorption isotherms of an activated carbon employed for the purposes of the present invention (solid triangles) and of a comparative carbon (solid squares);
the activated carbon underlying FIG. 1 comprises a polymer-based spherical activated carbon (PBSAC) having a BET surface area of 1671 m²/g and a total pore volume, in particular a Gurvich total pore volume, of 0.9071 cm³/g coupled with a not less than 60% proportion of pores having a pore diameter of up to 50 nm; in addition, the activated carbon used for the purposes of the present invention has an ash content of 0.5 wt %, a wettability of 50% and an approximately 2.88 fractal dimension of open porosity; the comparative carbon employed is a coconutshell-based granulocarbon which has a BET surface area of 1.087 m²/g and a total pore volume, in particular a Gurvich total pore volume, of 0.6136 cm³/g; in addition, the proportion of pores having a pore diameter of up to 50 nm is distinctly less than 60%, and the corresponding comparative carbons have an ash content of 1.6 wt % and also a wettability of 30%; in addition, the granulocarbon has an approximately 2.95 fractal dimension of open porosity;

FIG. 1 illustrates that the PBSAC activated carbon of the present invention altogether adsorbs a larger amount/volume of water and that the activated carbon employed for the purposes of the present invention is less hydrophilic than the granulocarbon and/or is hydrophobic as compared with the granulocarbon, since at low p/p₀ values the activated carbon employed for the purposes of the present invention takes up water in smaller amounts than the granulocarbon; as noted above, the activated carbon employed for the purposes of the present invention has significantly improved properties for reducing biofouling/biocontamination in the use as filter material for fluidic media;

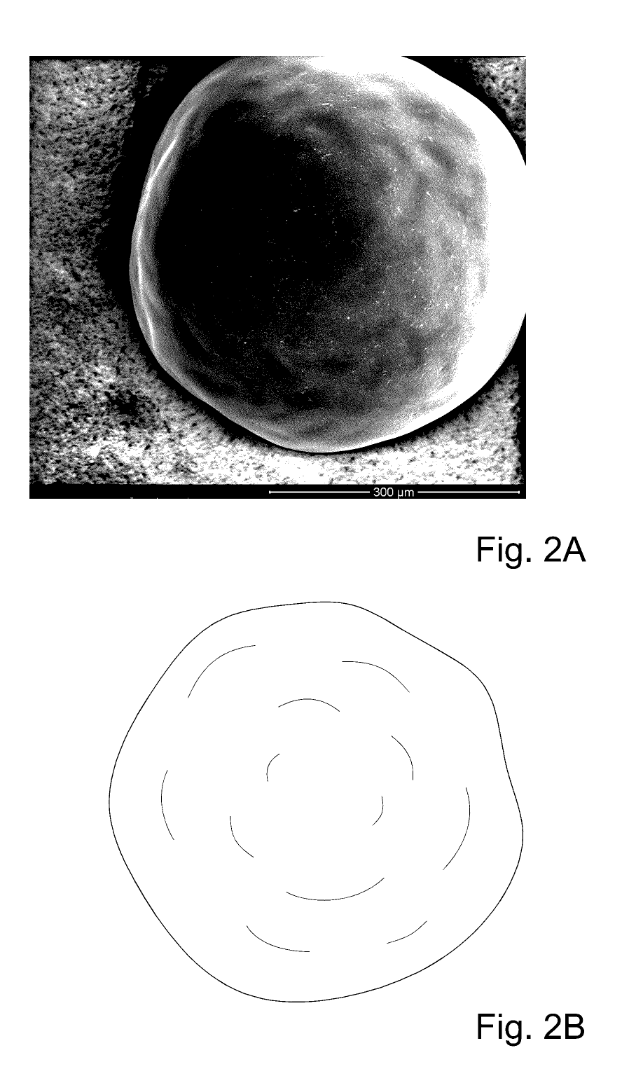

FIG. 2A shows a scanning electron micrograph (SEM) image (plan view of an activated carbon corpuscle) of a polymer-based spherical activated carbon (PBSAC) employed for the purposes of the present invention; the picture shows the spherical shape and the smooth surface of the activated carbon employed for the purposes of the present invention;

FIG. 2B shows a schematic depiction of an activated carbon employed for the purposes of the present invention (a schematic depiction corresponding to FIG. 2A) to clarify the spherical shape and the smooth surface of the activated carbon employed for the purposes of the present invention;

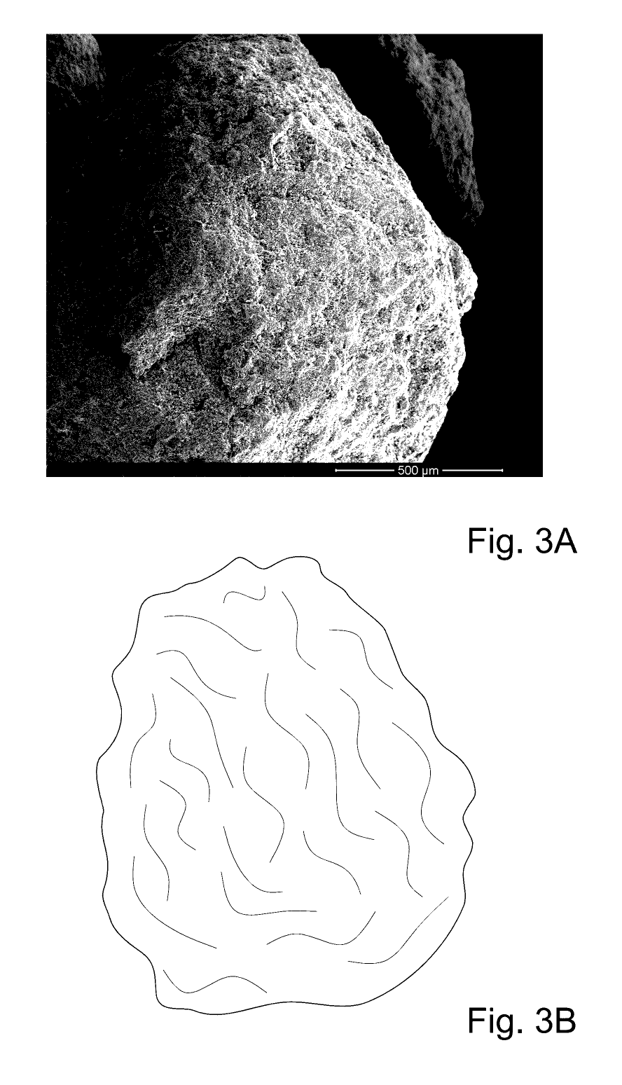

FIG. 3A shows a scanning electron micrograph (SEM) image (plan view of an activated carbon corpuscle) of an activated carbon not employed in the context of the present invention, viz., a granulocarbon based on coconutshell; the picture shows the irregular/granular shape and the rough surface of the corresponding comparative carbon;

FIG. 3B shows a schematic depiction of an activated carbon not employed in the context of the present invention (a schematic depiction corresponding to FIG. 3A) to clarify the irregular, granular shape; the depiction clarifies the irregular shape and the high surface roughness of the corresponding comparative carbon;

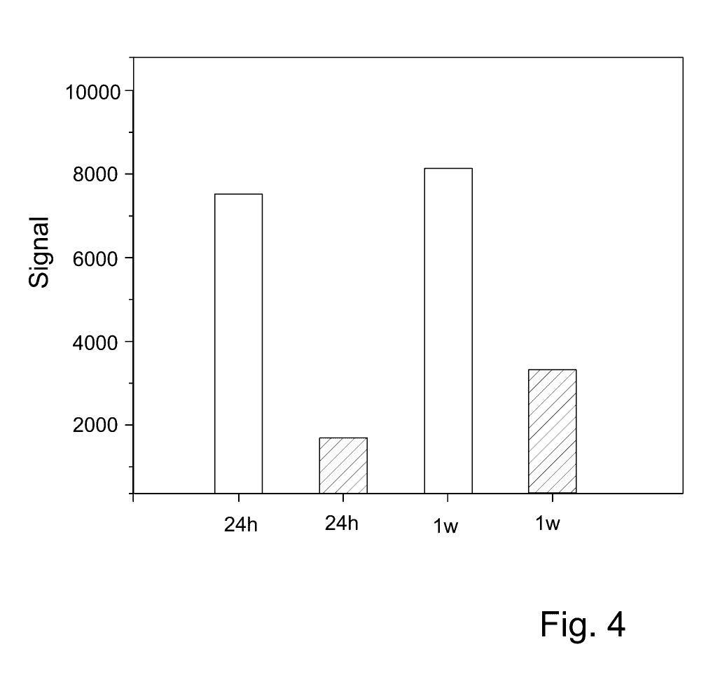

FIG. 4 shows a graphic depiction in the form of a bar diagram of experimental results as per Example 2.) (cf. the remarks hereinbelow regarding Example 2.)); the bars illustrate the fouling/colonization of the particular activated carbon after 24 hours (24 h) and/or after one week (1 w) for a comparative carbon in the form of a granulocarbon based on coconutshell (blank bars) and for a polymer-based spherical activated carbon (PBSAC) employed for the purposes of the present invention (hatched bars) (cf. also remarks regarding FIG. 1 and Example 2.)); the y-axis shows the measured microbial/bacterial signals, and the x-axis indicates the run times in each case; the graphic depiction illustrates the significantly lower microbial fouling and/or the significantly lower germ load for the activated carbons employed for the purposes of the present invention versus the corresponding comparative carbon.

The present invention, in a further aspect of the present invention, further provides the method of extending the in-service and/or on-stream life of an adsorptive filtering unit, preferably as defined above, in particular a method of improving and/or increasing the stability and/or resistance of an adsorptive filtering unit, in particular as defined above, to biocontamination and/or biofouling,

comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached.

The activated carbon therein should have a hydrophilicity, determined as water vapor adsorption behavior, such that at a partial pressure p/p₀ of 0.6 not more than 25%, in particular not more than 20%, preferably not more than 10%, more preferably not more than 5%, of the maximum water vapor adsorption capacity of the activated carbon is exhausted and/or utilized. In particular at a partial pressure p/p₀ of 0.6 not more than 25%, in particular not more than 20%, preferably not more than 10%, more preferably not more than 5%, of the maximum water vapor saturation loading of the activated carbon should be reached.

In this context, the activated carbon should similarly have a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized. In particular at a partial pressure p/p₀ of 0.6 0.1% to 30%, in particular 0.5% to 25%, preferably 1% to 20%, more preferably 1.5% to 15%, yet more preferably 2% to 10%, of the maximum water vapor saturation loading of the activated carbon should reached.

In the method of the present invention, for loading/cleaning purposes, the filtering unit of the invention, in particular the particulate adsorbent in the form of the spherical activated carbon, is brought into contact with the fluidic medium, preferably water, more preferably wastewater or tapwater, to be treated and/or cleaned.

In this context, the method of the present invention should be carried out by sending the medium to be cleaned through the active filtering unit, causing the medium to be cleaned to come into contact with the activated carbon to thereby remove specifically organic or inorganic, specifically organobased, impurities from the fluidic medium by adsorption.

In this aspect of the present invention, the present invention similarly provides methods of extending the in-service and/or on-stream life of an adsorptive filtering unit, preferably as defined above, in particular a method of improving and/or increasing the stability and/or resistance of a filtering unit, in particular as defined above, to biocontamination and/or biofouling, in particular the method defined above, comprising the step of endowing and/or equipping the filtering unit with at least one particulate adsorbent in the form of a spherical activated carbon, wherein the activated carbon has a total pore volume, in particular a Gurvich total pore volume, in the range from 0.15 cm³/g to 3.95 cm³/g,

wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and wherein the activated carbon has a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably 2.75, yet even still more preferably 2.7, and/or wherein the activated carbon has a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7.

In this context, it may be provided that the activated carbon has an ash content of not more than 1 wt %, in particular not more than 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon. The activated carbon should additionally have an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

The procedure provided by the present invention uses very specific activated carbons to thus ensure, in the context of the present invention, that the underlying filtering elements of the invention have a very long in-service/on-stream life by virtue of the low biocontamination while at the same time ensuring a high level of adsorption efficiency and hence effective cleaning of the underlying media of organically and/or inorganically based impurities.

The present invention, in a further aspect of the present invention, further also provides a method of treating and/or cleaning a fluidic medium, preferably water, more preferably wastewater or tapwater, in particular for adsorptive removal of inorganically or organically, in particular organically, based impurities from the fluidic medium,

comprising the step of utilizing an adsorptive filtering unit, in particular as defined above,
comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores,
wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached, and
wherein the filtering unit, in particular the particulate adsorbent in the form of the spherical activated carbon, is brought into contact with a or the fluidic medium, preferably water, more preferably wastewater or tapwater, to be treated and/or cleaned.

According to the invention, the activated carbon employed in said method should have a hydrophilicity, determined as water vapor adsorption behavior, such that at a partial pressure p/p₀ of 0.6 not more than 25%, in particular not more than 20%, preferably not more than 10%, more preferably not more than 5%, of the maximum water vapor adsorption capacity of the activated carbon is exhausted and/or utilized. In particular at a partial pressure p/p₀ of 0.6 not more than 25%, in particular not more than 20%, preferably not more than 10%, more preferably not more than 5%, of the maximum water vapor saturation loading of the activated carbon should be reached.

More particularly, the activated carbon should have a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized. In particular at a partial pressure p/p₀ of 0.6 0.1% to 30%, in particular 0.5% to 25%, preferably 1% to 20%, more preferably 1.5% to 15%, yet more preferably 2% to 10%, of the maximum water vapor saturation loading of the activated carbon should be reached.

The present invention in this aspect similarly also provides a method of treating and/or cleaning a fluidic medium, preferably water, more preferably wastewater or tapwater, in particular for adsorptive removal of inorganically or organically, in particular organical, based impurities from the fluidic medium, in particular the method as defined above, comprising the step of utilizing an adsorptive filtering unit, in particular as defined above,

comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores,
wherein the activated carbon has a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably 2.75, yet even still more preferably 2.7, and/or wherein the activated carbon has a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7 and
wherein the filtering unit, in particular the particulate adsorbent in the form of the spherical activated carbon, is brought into contact with a or the fluidic medium, preferably water, more preferably wastewater or tapwater, to be treated and/or cleaned.

In this context, the activated carbon should have an ash content of not more than 1 wt %, in particular not more than 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon. Similarly the activated carbon should have an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

The present invention, in a further aspect of the present invention, further provides the method of using a particulate adsorbent in the form of a spherical activated carbon to extend the in-service and/or on-stream life, in particular to improve and/or increase the stability and/or resistance to biocontamination, of an adsorptive filtering unit, in particular as defined above, wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and

wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached.

According to this aspect of the present invention, the filter therein may be endowed with the activated carbon described above.

The present invention similarly also provides the method of using a particulate adsorbent in the form of a spherical activated carbon to treat and/or clean a fluidic medium, preferably water, more preferably wastewater or tapwater, in particular for adsorptive removal of inorganically or organically, in particular organically, based impurities, wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached.

In this context, the activated carbon should have a hydrophilicity, determined as water vapor adsorption behavior, such that at a partial pressure p/p₀ of 0.6 not more than 25%, in particular not more than 20%, preferably not more than 10%, more preferably not more than 5%, of the maximum water vapor adsorption capacity of the activated carbon is exhausted and/or utilized. In addition at a partial pressure p/p₀ of 0.6 not more than 25%, in particular not more than 20%, preferably not more than 10%, more preferably not more than 5%, of the maximum water vapor saturation loading of the activated carbon should be reached.

In addition, the activated carbon should have a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized. In particular at a partial pressure p/p₀ of 0.6 0.1% to 30%, in particular 0.5% to 25%, preferably 1% to 20%, more preferably 1.5% to 15%, yet more preferably 2% to 10%, of the maximum water vapor saturation loading of the activated carbon should be reached.

In particular, the activated carbon should have a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably 2.75, yet even still more preferably 2.7. In particular, the activated carbon should have a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7.

In addition, the activated carbon should have an ash content of not more than 1 wt %, in particular not more than 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon. In particular, the activated carbon should have an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

As noted above, the present inventors are the first to succeed in providing a concept whereby the purpose-directed, precise use of a very specific activated carbon, as defined above, for corresponding filtering units/elements achieves a significantly reduced level of biofouling/biocontamination in the context of employing the filtering units for filtering purposes.

This is another reason why the filtering unit provided according to the present invention is suitable for numerous uses in connection with the treatment/cleaning of a fluidic medium:

In a further aspect of the present invention, the present invention thus also provides for the methods of using the filtering unit of the invention in the manner of the invention.

Accordingly, the filtering unit of the present invention is useful for treating and/or cleaning a fluidic medium, preferably water, more preferably wastewater or tapwater, in particular for adsorptive removal of inorganically or organically, in particular organically, based impurities from the fluidic medium.

In this context, the filtering unit of the present invention is more particularly suitable for use in the context of cleaning/reconditioning wastewater. The filtering unit of the present invention is additionally also useful for providing/cleaning tapwater.

The filtering unit of the present invention is similarly also useful for gas purification and/or gas regeneration.

The filtering unit of the present invention is more particularly useful for the removal of noxiants, in particular gaseous noxiants, or of toxic, harmful or environmentally damaging substances or gases.

The filtering unit of the present invention is lastly also useful for regenerating and/or providing cleanroom atmospheres, in particular for the electrical/electronics industry, in particular for semiconductor or chip manufacture.

The filtering unit of the present invention is generally suitable for any gas- or liquid-phase applications, which in this context specifically also includes the possibility of adsorbing persistent compounds from surface water. As noted above, the filtering unit of the present invention is also suitable for tapwater regeneration, wherein activated carbon filters are generally employed prior to any disinfecting step to be carried out. The but minimal biofouling of the adsorbent employed for the purposes of the present invention even after long in-service periods results in distinctly lower contamination of the medium to be cleaned.

The filtering unit of the present invention is therefore also suitable for use in ultrapure water regeneration.

As noted above, the filtering unit of the present invention is also suitable for application in the gas phase and particularly for cleaning (moist) airstreams where any bacterial fouling of the underlying activated carbon is at a minimal, at worst, and moist air is advantageously filtered through the underlying activated carbon filter. As noted above, service in this regard is possible in the form of air filters, in particular for cleanrooms, respirator filters or else in the form of filtering systems, for example for fume extractor hoods.

The present invention is thus altogether geared to employing a specific spherical activated carbon, which is in particular in the form of a polymer-based spherical activated carbon. Activated carbons of this type, when tested in appropriate flowthrough experiments against conventional granulocarbons, attract an extremely low level of fouling with microorganisms and/or bacteria. This significantly reduced level of fouling with bacteria in the aqueous phase is also attributable to the very smooth surface and/or minimal surface roughness of the spherical activated carbon, in that bacterial colonization and/or microbial fouling is correspondingly reduced/prevented.

Further versions, alterations, variations, modifications, special features and advantages of the present invention will be readily apparent to and realizable by the ordinarily skilled on reading the description without their having to go outside the realm of the present invention.

The present invention is illustrated by the following exemplary embodiments which, however, shall in no way limit the present invention.

### Exemplary Embodiments

### 1. Determination of Wetting/Wettability for the Activated Carbons Employed for the Purposes of the Present Invention

The rate of uptake of water by adsorbents, such as activated carbon, and also the corresponding capacity to the point of exterior wetting play an important part in the concept of the present invention to provide filtering units having minimal biofouling/biocontamination for the underlying adsorbent under service/use conditions.

The procedure described can be used to quantify not only the water uptake rate but also the water uptake quantity until the adsorbents exhibit external wetting. The underlying principle of the test involves the in-test adsorbents being admixed with water a little at a time in an Erlenmeyer flask under constant shaking until they exhibit the onset of exterior wetting. External/exterior wetting is indicated by moistened/moist activated carbon material sticking to the wall of the Erlenmeyer flask after shaking has taken place.

Specifically, wettability is determined by weighing 10 g of the in-test activated carbon into an Erlenmeyer flask and subsequently adding 2 g of distilled water by using a dropping pipette. The Erlenmeyer flask is subsequently sealed and shaken until the initially charged adsorbents and/or the activated carbon material is surficially dry.

Next the water quantity required for the onset of exterior wetting is admixed in steps of 0.5 g. After every admixture, the Erlenmeyer flask is shaken for around 3 minutes. Any activated carbon material sticking/adhering to the walling of the Erlenmeyer flask in the process is not removed and/or scraped off. Admixing water required to wet the activated carbon is ended when corresponding activated carbon particles stay stuck/adhered to the walling of the flask after shaking the Erlenmeyer flask for a period of 3 minutes. Wettability can be determined as per the following formula:

wettability [%]=admixed amount of H₂O [g]/10 g (amount of activated carbon material)·100

A polymer-based spherical activated carbon (PBSAC) as described under FIG. 1 and employed for the purposes of the present invention is tested in this context. The result is a corresponding wettability of 50%.

For comparison, a granulocarbon based on coconutshell is also tested (cf. remarks regarding FIG. 1). A wettability of nearly 30% was found for the corresponding granulocarbon.

### 2. Test for Microbial Fouling of Activated Carbons

a) The activated carbons adduced in Example 1, viz., the polymer-based spherical activated carbon (PBSAC) employed for the purposes of the present invention (activated carbon A) and the coconutshell-based granulocarbon (activated carbon B) are tested by means of column experiments for their biofouling/germ load by use of river water.
   The river water used naturally contains a defined population of microorganisms which may establish a colony/germ load on activated carbon.
   The in-test activated carbons are packed at a volume of 40 ml into plastic syringe barrels (50 ml) and subjected to the flow of the river water via a multichannel peristaltic pump. Each series of tests employed 4 columns in each case. Samples were taken after 24 hours and also after one week. This was done by using a spatula to take one sample in each case from the surface of the column.
   The corresponding samples are examined by confocal laser scanning microscopy (CLSM). To this end, the activated carbon corpuscles in each case are stained with a nucleic acid specific fluorochrome (SybrGreen) in a cover glass chamber. The cover glass chambers are sealed with a cover glass and examined via CLSM.
   Of each sample, 15 particles are microscoped at the particular point in time. Not only the fluorescence from the microorganisms is recorded, but also the reflection from the particles as background signal. The signals from the microorganisms are subsequently quantified and averaged. The results are displayed as a so-called maximum intensity projection (MIP). The results are graphed in a bar diagram (cf. FIG. 4);
   FIG. 4 shows overall the quantification of the microbial contamination found for each activated carbon via confocal laser scanning microscopy (CLSM), by means of the respective detected measuring signals. Granulocarbon B in the test is found to display distinct fouling with microorganisms after a test period of just 24 hours, whereas activated carbon A (a PBSAC), employed for the purposes of the present invention, only displays a minimal degree of fouling with microorganisms. This holds in a corresponding manner for the degree of contamination and a one week run.
   The result to be put on record is accordingly that, in relation to the granulocarbon as per activated carbon B, there is a distinct level of fouling/colonization with microorganisms after just 24 hours and all the more after one week. Corresponding biocontamination on activated carbon A, employed for the purposes of the present invention, is significantly less by comparison. Even after a one week run, the microbial fouling on activated carbon A, employed for the purposes of the present invention, merely amounts to about 40% of that on comparative carbon B in the form of granulocarbon.
b) In addition, further activated carbons are tested according to section a). The following polymer-based activated carbons are concerned here in detail:
   Activated carbon C in the test comprises an activated carbon having a distinctly higher hydrophilicity than activated carbon A, employed for the purposes of the present invention, in that in relation to activated carbon C about 45% of the maximum water vapor saturation loading of the activated carbon is reached at a partial pressure p/p₀. Activated carbon C gives a microbial/bacterial signal of 4970 after 24 hours and of 6814 after one week.
   A further activated carbon tested—activated carbon D—has a 2.96 fractal dimension of open porosity and thus a relatively large surface roughness. Activated carbon D in the test gave 3975 signals after 24 hours and 5231 signals after one week.
   A further activated carbon tested—activated carbon E—has an ash content of 1.35 wt %. Activated carbon E in the test gave 4183 signals after 24 hours and 6365 signals after one week.

The adduced tests verify altogether that the combination in the present invention with the use of a very specific activated carbon having defined pore and surface properties and having specific shaping and also based on specific starting materials provides the filter material used for adsorptive filtering applications with outstanding properties in relation to an effective reduction in biofouling of and/or germ load on the activated carbons employed in this manner.

1. A method of providing an adsorptive filtering unit having an extended in-service and/or on-stream life, in particular having improved and/or increased stability and/or resistance to biocontamination and/or biofouling, in particular an adsorptive filtering unit for treating and/or cleaning a fluidic medium, preferably water, more preferably wastewater or tapwater, and/or in particular for adsorptive removal of inorganically or organically, in particular organically, based impurities,
comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached.

2. The method as claimed in claim 1 wherein the activated carbon has a hydrophilicity, determined as water vapor adsorption behavior, such that at a partial pressure p/p₀ of 0.6 not more than 25%, in particular not more than 20%, preferably not more than 10%, more preferably not more than 5%, of the maximum water vapor adsorption capacity of the activated carbon is exhausted and/or utilized, and/or wherein at a partial pressure p/p₀ of 0.6 not more than 25%, in particular not more than 20%, preferably not more than 10%, more preferably not more than 5%, of the maximum water vapor saturation loading of the activated carbon is reached.

3. The method as claimed in claim 1 or 2 wherein the activated carbon has a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized, and/or wherein at a partial pressure p/p₀ of 0.6 0.1% to 30%, in particular 0.5% to 25%, preferably 1% to 20%, more preferably 1.5% to 15%, yet more preferably 2% to 10%, of the maximum water vapor saturation loading of the activated carbon is reached.

4. The method as claimed in any preceding claim wherein the activated carbon has a hydrophilicity, determined as water vapor adsorption behavior, such that at a partial pressure p/p₀ of 0.6 the activated carbon has adsorbed a water vapor quantity (H₂O volume) V_{ads(H2O)} which, based on the weight of the activated carbon, amounts to not more than 200 cm³/g, in particular to not more than 175 cm³/g, preferably to not more than 150 cm³/g, more preferably to not more than 100 cm³/g, yet more preferably to not more than 75 cm³/g.

5. The method as claimed in any preceding claim wherein the activated carbon has a hydrophilicity, determined as water vapor adsorption behavior, such that at a partial pressure p/p₀ of 0.6 the activated carbon has adsorbed a water vapor quantity (H₂O volume) V_{ads(H2O)} which, based on the weight of the activated carbon, is in the range from 10 cm³/g to 200 cm³/g, in particular 20 cm³/g to 175 cm³/g, preferably 30 cm³/g to 150 cm³/g, more preferably 40 cm³/g to 100 cm³/g, yet more preferably 50 cm³/g to 75 cm³/g.

6. The method as claimed in any preceding claim wherein the activated carbon has a hydrophilicity, determined as water vapor adsorption behavior, such that in a partial pressure range p/p₀ of 0.1 to 0.6 not more than 25%, in particular not more than 20%, preferably not more than 10%, more preferably not more than 5%, of the maximum water vapor adsorption capacity of the activated carbon is exhausted and/or utilized, and/or wherein in a partial pressure range p/p₀ of 0.1 to 0.6 not more than 25%, in particular not more than 20%, preferably not more than 10%, more preferably not more than 5%, of the maximum water vapor saturation loading of the activated carbon is reached.

7. The method as claimed in any preceding claim wherein the activated carbon has a hydrophilicity, determined as water vapor adsorption behavior, such that in a partial pressure range p/p₀ of 0.1 to 0.6 0.05% to 30%, in particular 0.1% to 25%, preferably 0.5% to 20%, more preferably 1% to 15%, yet more preferably 1% to 10%, of the maximum water vapor adsorption capacity of the activated carbon is exhausted and/or utilized, and/or wherein in a partial pressure range p/p₀ of 0.1 to 0.6 0.05% to 30%, in particular 0.1% to 25%, preferably 0.5% to 20%, more preferably 1% to 15%, yet more preferably 1% to 10%, of the maximum water vapor saturation loading of the activated carbon is reached.

8. The method according to any preceding claim wherein the activated carbon has a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably not more than 2.75, yet even still more preferably not more than 2.7, and/or wherein the activated carbon has a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7.

9. The method as claimed in any preceding claim wherein the activated carbon has an ash content of not more than 1 wt %, in particular not more than 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon, and/or wherein the activated carbon has an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

10. The method as claimed in any preceding claim wherein the activated carbon is obtainable by carbonizing and then activating a synthetic and/or non-naturally based starting material, in particular based on organic polymers.

11. The method as claimed in any preceding claim wherein the activated carbon is obtained from a starting material based on organic polymers, in particular based on sulfonated organic polymers, preferably based on divinylbenzene-crosslinked polystyrene, more preferably based on styrene-divinylbenzene copolymers, in particular by carbonizing and then activating the starting material.

12. The method as claimed in claim 11 wherein the divinylbenzene content of the starting material is in the range from 1 wt % to 20 wt %, in particular 1 wt % to 15 wt %, preferably 1.5 wt % to 12.5 wt %, more preferably 2 wt % to 10 wt %, based on the starting material.

13. The method as claimed in any of claims 10 to 12 wherein the starting material is a specifically sulfonated and/or sulfo-containing ion exchange resin, in particular of the gel type.

14. The method as claimed in any preceding claim wherein a polymer-based spherical activated carbon (PBSAC) is used as activated carbon, and/or wherein the activated carbon is a polymer-based spherical activated carbon (PBSAC).

15. The method as claimed in any preceding claim wherein the activated carbon has a total pore volume, in particular a Gurvich total pore volume, in the range from 0.3 cm³/g to 3.8 cm³/g, in particular 0.4 cm³/g to 3.5 cm³/g, preferably 0.5 cm³/g to 3 cm³/g, more preferably 0.6 cm³/g to 2.5 cm³/g, yet more preferably 0.7 cm³/g to 2 cm³/g.

16. The method as claimed in any preceding claim wherein not less than 65%, in particular not less than 70%, preferably not less than 75%, more preferably not less than 80%, of the total pore volume, in particular of the Gurvich total pore volume, of the activated carbon is formed by pores having pore diameters of not more than 50 nm, in particular by micro- and/or mesopores.

17. The method as claimed in any preceding claim wherein 60% to 90%, in particular 65% to 85%, preferably 70% to 80%, of the total pore volume, in particular of the Gurvich total pore volume, of the activated carbon is formed by pores having pore diameters of not more than 50 nm, in particular by micro- and/or mesopores.

18. The method as claimed in any preceding claim wherein 5% to 80%, in particular 10% to 70%, preferably 20% to 60%, of the total pore volume, in particular of the Gurvich total pore volume, of the activated carbon is formed by pores having pore diameters in the range from 2 nm to 50 nm, in particular by mesopores.

19. The method as claimed in any preceding claim wherein 1% to 60%, in particular 5% to 40%, preferably 10% to 35%, more preferably 15% to 33% of the total pore volume, in particular of the Gurvich total pore volume, of the activated carbon is formed by pores having pore diameters of more than 2 nm, in particular by meso- and/or macropores.

20. The method as claimed in any preceding claim wherein the activated carbon has a pore volume, in particular a carbon black micropore volume formed by pores having pore diameters of not more than 2 nm (i.e., ≦2 nm) in the range from 0.05 cm³/g to 2.1 cm³/g, in particular 0.15 cm³/g to 1.8 cm³/g, preferably 0.3 cm³/g to 1.4 cm³/g, more preferably 0.5 cm³/g to 1.2 cm³/g, yet more preferably 0.6 cm³/g to 1.1 cm³/g, in particular wherein 15% to 98%, in particular 25% to 95%, preferably 35% to 90% of the total pore volume of the activated carbon is formed by pores having pore diameters of not more than 2 nm, in particular by micropores.

21. The method as claimed in any preceding claim wherein the activated carbon has a specific BET surface area in the range from 600 m²/g to 4000 m²/g, in particular 800 m²/g to 3500 m²/g, preferably 1000 m²/g to 3000 m²/g, more preferably 1200 m²/g to 2750 m²/g, yet more preferably 1300 m²/g to 2500 m²/g, yet still more preferably 1400 m²/g to 2250 m²/g.

22. The method as claimed in any preceding claim wherein the activated carbon has a surface area formed by pores having pore diameters of not more than 2 nm, in particular by micropores, that is in the range from 400 to 3500 m²/g, in particular 500 to 3000 m²/g, preferably 700 to 2500 m²/g, more preferably 700 to 2000 m²/g.

23. The method as claimed in any preceding claim wherein the activated carbon has a surface area formed by pores having pore diameters in the range from 2 nm to 50 nm, in particular by mesopores, that is in the range from 200 to 2000 m²/g, in particular 300 to 1900 m²/g, preferably 400 to 1800 m²/g, more preferably 500 to 1700 m²/g.

24. The method as claimed in any preceding claim wherein the activated carbon has an average pore diameter in the range from 0.5 nm to 55 nm, in particular 0.75 nm to 50 nm, preferably 1 nm to 45 nm, more preferably 1.5 nm to 35 nm, yet more preferably 1.75 nm to 25 nm, yet still more preferably 2 nm to 15 nm, yet even still more preferably 2.5 nm to 10 nm, most preferably 2.75 nm to 5 nm.

25. The method as claimed in any preceding claim wherein the activated carbon has a particle size, in particular a corpuscle diameter, in the range from 0.1 mm to 2.5 mm, in particular 0.02 mm to 2 mm, preferably 0.05 mm to 1.5 mm, more preferably 0.01 mm to 1.25 mm, yet more preferably 0.15 mm to 1 mm, yet still more preferably 0.2 mm to 0.8 mm, in particular wherein not less than 70 wt %, in particular not less than 80 wt %, preferably not less than 85 wt %, more preferably not less than 90 wt % of the activated carbon particles, yet more preferably not less than 95 wt %, of the activated carbon particles, especially activated carbon corpuscles have particle sizes, in particular corpuscle diameters, in the aforementioned ranges.

26. The method as claimed in any preceding claim wherein the activated carbon has a median particle size (D50), in particular a median corpuscle diameter (D50), in the range from 0.1 mm to 1.2 mm, in particular 0.15 mm to 1 mm, preferably 0.2 mm to 0.9 mm, more preferably 0.25 mm to 0.8 mm, yet more preferably 0.3 mm to 0.6 mm.

27. The method as claimed in any preceding claim wherein the activated carbon has a tapped and/or tamped density in the range from 150 g/l to 1800 g/l, in particular from 175 g/l to 1400 g/l, preferably 200 g/l to 900 g/l, more preferably 250 g/l to 800 g/l, yet more preferably 300 g/l to 750 g/l, yet still more preferably 350 g/l to 700 g/l.

28. The method as claimed in any preceding claim wherein the activated carbon has a bulk density in the range from 200 g/l to 1100 g/l, in particular from 300 g/l to 800 g/l, preferably 350 g/l to 650 g/l, more preferably 400 g/l to 595 g/l.

29. The method as claimed in any preceding claim wherein the activated carbon has a ball pan hardness and/or abrasion hardness of not less than 92%, in particular not less than 96%, preferably not less than 97%, more preferably not less than 98%, yet more preferably not less than 98.5%, yet still more preferably not less than 99%, yet still even more preferably not less than 99.5%.

30. The method as claimed in any preceding claim wherein the activated carbon has a compressive and/or bursting strength (weight-bearing capacity) per activated carbon grain, in particular per activated carbon spherule, of not less than 5 newtons, in particular not less than 10 newtons, preferably not less than 15 newtons, more preferably not less than 20 newtons, and/or wherein the activated carbon has a compressive and/or bursting strength (weight-bearing capacity) per activated carbon grain, in particular per activated carbon spherule, in the range from 5 to 50 newtons, in particular 10 to 45 newtons, preferably 15 to 40 newtons.

31. The method as claimed in any preceding claim wherein the activated carbon has a water and/or moisture content in the range from 0.05 wt % to 3 wt %, in particular 0.1 wt % to 2 wt %, preferably 0.15 wt % to 1.5 wt %, more preferably 0.175 wt % to 1 wt %, yet more preferably 0.2 wt % to 0.75 wt %, based on the activated carbon.

32. The method as claimed in any preceding claim wherein the activated carbon has a wettability, in particular water wettability, of not less than 35%, in particular not less than 40%, preferably not less than 45%, more preferably not less than 50%, yet more preferably not less than 55%, and/or wherein the activated carbon has a wettability, in particular water wettability, in the range from 35% to 90%, in particular 40% to 85%, preferably 45% to 80%, more preferably 50% to 80%, yet more preferably 55% to 75%.

33. The method as claimed in any preceding claim wherein the activated carbon has an iodine number of not less than 1100 mg/g, in particular not less than 1200 mg/g, preferably not less than 1300 mg/g, and/or wherein the activated carbon has an iodine number in the range from 1100 to 2000 mg/g, in particular 1200 to 1800 mg/g, preferably 1300 to 1600 mg/g.

34. The method as claimed in any preceding claim wherein the activated carbon has a butane adsorption of not less than 25%, in particular not less than 30%, preferably not less than 40%, and/or wherein the activated carbon has a butane adsorption in the range from 25 to 80%, in particular 30 to 70%, preferably 35 to 65%.

35. A method of providing an adsorptive filtering unit having an extended in-service and/or on-stream life, in particular having improved and/or increased stability and/or resistance to biocontamination and/or biofouling, in particular an adsorptive filtering unit for treating and/or cleaning a fluidic medium, preferably water, more preferably wastewater or tapwater, and/or in particular for adsorptive removal of inorganically or organically, in particular organically, based impurities, in particular a method as claimed in any preceding claim,
comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized, and/or wherein at a partial pressure p/p₀ of 0.6 0.1% to 30%, in particular 0.5% to 25%, preferably 1% to 20%, more preferably 1.5% to 15%, yet more preferably 2% to 10%, of the maximum water vapor saturation loading of the activated carbon is reached.

36. A method of providing an adsorptive filtering unit having an extended in-service and/or on-stream life, in particular having improved and/or increased stability and/or resistance to biocontamination and/or biofouling, in particular an adsorptive filtering unit for treating and/or cleaning a fluidic medium, preferably water, more preferably wastewater or tapwater, and/or in particular for adsorptive removal of inorganically or organically, in particular organically, based impurities, in particular a method as claimed in any preceding claim,
comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a hydrophilicity, determined as water vapor adsorption behavior, such that at a partial pressure p/p₀ of 0.6 the activated carbon has adsorbed a water vapor quantity (H₂O volume) V_{ads(H2O)} which, based on the weight of the activated carbon, amounts to not more than 200 cm³/g, in particular to not more than 175 cm³/g, preferably to not more than 150 cm³/g, more preferably to not more than 100 cm³/g, yet more preferably to not more than 75 cm³/g.

37. A method of providing an adsorptive filtering unit having an extended in-service and/or on-stream life, in particular having improved and/or increased stability and/or resistance to biocontamination and/or biofouling, in particular an adsorptive filtering unit for treating and/or cleaning a fluidic medium, preferably water, more preferably wastewater or tapwater, and/or in particular for adsorptive removal of inorganically or organically, in particular organically, based impurities, in particular a method as claimed in any preceding claim,
comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably not more than 2.75, yet even still more preferably not more than 2.7, and/or wherein the activated carbon has a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7.

38. A method of providing an adsorptive filtering unit having an extended in-service and/or on-stream life, in particular having improved and/or increased stability and/or resistance to biocontamination and/or biofouling, in particular an adsorptive filtering unit for treating and/or cleaning a fluidic medium, preferably water, more preferably wastewater or tapwater, and/or in particular for adsorptive removal of inorganically or organically, in particular organically, based impurities, in particular a method as claimed in any preceding claim,
comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has an ash content of not more than 1 wt %, in particular 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon, and/or wherein the activated carbon has an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

39. An adsorptive filtering unit having an extended in-service and/or on-stream life, in particular having improved and/or increased stability and/or resistance to biocontamination and/or biofouling, in particular a filtering unit for treating and/or cleaning a fluidic medium, preferably water, more preferably wastewater or tapwater, and/or in particular for adsorptive removal of inorganically or organically, in particular organically, based impurities, obtainable according to a method as claimed in any preceding claim.

40. An adsorptive filtering unit having an extended in-service and/or on-stream life, in particular having improved and/or increased stability and/or resistance to biocontamination and/or biofouling, in particular for treating and/or cleaning a fluidic medium, preferably water, more preferably wastewater or tapwater, and/or in particular for adsorptive removal of inorganically or organically, in particular organically, based impurities,
wherein the filtering unit comprises at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% of the total pore volume, in particular of the Gurvich total pore volume, of the activated carbon is formed by pores having pore diameters of not more than 50 nm, in particular by micro- and/or mesopores, and
wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached.

41. The filtering unit as claimed in claim 40 wherein the activated carbon has a hydrophilicity, determined as water vapor adsorption behavior, such that at a partial pressure p/p₀ of 0.6 not more than 25%, in particular not more than 20%, preferably not more than 10%, more preferably not more than 5%, of the maximum water vapor adsorption capacity of the activated carbon is exhausted and/or utilized, and/or wherein at a partial pressure p/p₀ of 0.6 not more than 25%, in particular not more than 20%, preferably not more than 10%, more preferably not more than 5%, of the maximum water vapor saturation loading of the activated carbon is reached.

42. The filtering unit as claimed in claim 40 or 41 wherein the activated carbon has a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized, and/or wherein at a partial pressure p/p₀ of 0.6 0.1% to 30%, in particular 0.5% to 25%, preferably 1% to 20%, more preferably 1.5% to 15%, yet more preferably 2% to 10%, of the maximum water vapor saturation loading of the activated carbon is reached.

43. The filtering unit as claimed in any of claims 40 to 42 wherein the filtering unit comprises at least one carrier.

44. The filtering unit as claimed in any of claims 40 to 43 wherein the particulate adsorbent in the form of the spherical activated carbon is self-supporting and/or in the form of a specifically loose bed, in particular wherein the carrier is configured in the form of a housing specifically to accommodate the activated carbon.

45. The filtering unit as claimed in any of claims 40 to 43 wherein the particulate adsorbent in the form of the spherical activated carbon is mounted on the carrier and/or is in the form of a fixed bed, in particular wherein the carrier has a three-dimensional structure, in particular wherein the carrier is configured as a preferably open-cell foam, more preferably polyurethane foam, or else wherein the carrier has a two-dimensional and/or sheetlike structure, in particular wherein the carrier is configured as a preferably textile fabric.

46. The filtering unit as claimed in claim 45 wherein the carrier is configured to be liquid permeable, in particular water permeable, and/or gas permeable, in particular air permeable, in particular wherein the carrier has a gas permeability, in particular air permeability, of not less than 10 l·m⁻²·s⁻¹, in particular not less than 30 l·m⁻²·s⁻¹, preferably not less than 50 l·m⁻²·s⁻¹, more preferably not less than 100 l·m⁻²·s⁻¹, yet more preferably not less than 500 l·m⁻²·s⁻¹, and/or a gas permeability, in particular air permeability, of up to 10 000 l·m⁻²·s⁻¹, in particular up to 20 000 l·m⁻²·s⁻¹, at a flow resistance of 127 Pa.

47. The filtering unit as claimed in claim 45 or 46 wherein the carrier is configured as a textile fabric, preferably as an air-permeable textile material, preferably as a woven, knitted, laid or bonded textile fabric, in particular as a nonwoven fabric, and/or wherein the carrier has a basis weight of 5 to 1000 g/m², in particular 10 to 500 g/m², preferably 25 to 450 g/m².

48. The filtering unit as claimed in any of claims 45 to 47 wherein the carrier is a textile fabric containing or consisting of natural fibers and/or synthetic fibers (manufactured fibers), in particular wherein the natural fibers are selected from the group of wool fibers and cotton fibers (CO) and/or in particular wherein the synthetic fibers are selected from the group of polyesters (PES); polyolefins, in particular polyethylene (PE) and/or polypropylene (PP); polyvinyl chlorides (CLF); polyvinylidene chlorides (CLF); acetates (CA); triacetates (CTA); polyacrylics (PAN); polyamides (PA), in particular aromatic, preferably flameproof polyamides; polyvinyl alcohols (PVAL); polyurethanes; polyvinyl esters; (meth)acrylates; polylactic acids (PLA); activated carbon; and also mixtures thereof.

49. The filtering unit as claimed in any of claims 45 to 48 wherein the particulate adsorbent in the form of the spherical activated carbon is fixed to and/or on the carrier, preferably via adherence, in particular via an adhesive, or as a result of autoadhesion or of inherent tackiness.

50. The filtering unit as claimed in any of claims 45 to 49 wherein the filtering unit has a casing, in particular for the case whereby the particulate adsorbent in the form of the spherical activated carbon is mounted on the carrier and/or is in the form of a fixed bed.

51. An adsorptive filtering unit having an extended in-service and/or on-stream life, in particular having improved and/or increased stability and/or resistance to biocontamination and/or biofouling, in particular for treating and/or cleaning a fluidic medium, preferably water, more preferably wastewater or tapwater, and/or in particular for adsorptive removal of inorganically or organically, in particular organically, based impurities, in particular as claimed in any of claims 39 to 50,
wherein the filtering unit comprises at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% of the total pore volume, in particular of the Gurvich total pore volume, of the activated carbon is formed by pores having pore diameters of not more than 50 nm, in particular by micro- and/or mesopores, and
wherein the activated carbon has a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably not more than 2.75, yet even still more preferably not more than 2.7, and/or wherein the activated carbon has a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7.

52. The filtering unit as claimed in any of claims 39 to 51 wherein the activated carbon has an ash content of not more than 1 wt %, in particular not more than 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon, and/or wherein the activated carbon has an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

53. A method of extending the in-service and/or on-stream life of an adsorptive filtering unit, preferably as defined in any of claims 39 to 52, in particular a method of improving and/or increasing the stability and/or resistance of an adsorptive filtering unit, in particular as defined in any of claims 39 to 52, to biocontamination and/or biofouling,
comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached.

54. The method as claimed in claim 53 wherein the activated carbon has a hydrophilicity, determined as water vapor adsorption behavior, such that at a partial pressure p/p₀ of 0.6 not more than 25%, in particular not more than 20%, preferably not more than 10%, more preferably not more than 5%, of the maximum water vapor adsorption capacity of the activated carbon is exhausted and/or utilized, and/or wherein at a partial pressure p/p₀ of 0.6 not more than 25%, in particular not more than 20%, preferably not more than 10%, more preferably not more than 5%, of the maximum water vapor saturation loading of the activated carbon is reached.

55. The method as claimed in claim 53 or 54 wherein the activated carbon has a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized, and/or wherein at a partial pressure p/p₀ of 0.6 0.1% to 30%, in particular 0.5% to 25%, preferably 1% to 20%, more preferably 1.5% to 15%, yet more preferably 2% to 10%, of the maximum water vapor saturation loading of the activated carbon is reached.

56. The method as claimed in any of claims 53 to 55 wherein the filtering unit, in particular the particulate adsorbent in the form of the spherical activated carbon, is brought into contact with a fluidic medium, preferably water, more preferably wastewater or tapwater, to be treated and/or cleaned.

57. A method of extending the in-service and/or on-stream life of an adsorptive filtering unit, preferably as defined in any of claims 39 to 52, in particular a method of improving and/or increasing the stability and/or resistance of a filtering unit, in particular as defined in any of claims 39 to 52, to biocontamination and/or biofouling, in particular a method as claimed in any of claims 53 to 56,
comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably not more than 2.75, yet even still more preferably not more than 2.7, and/or wherein the activated carbon has a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7.

58. The method as claimed in any of claims 53 to 57 wherein the activated carbon has an ash content of not more than 1 wt %, in particular not more than 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon, and/or wherein the activated carbon has an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

59. A method of treating and/or cleaning a fluidic medium, preferably water, more preferably wastewater or tapwater, in particular for adsorptive removal of inorganically or organically, in particular organically, based impurities from the fluidic medium,
comprising the step of utilizing an adsorptive filtering unit, in particular as defined in any of claims 39 to 52, comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores,
wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached, and
wherein the filtering unit, in particular the particulate adsorbent in the form of the spherical activated carbon, is brought into contact with a or the fluidic medium, preferably water, more preferably wastewater or tapwater, to be treated and/or cleaned.

60. The method as claimed in claim 59 wherein the activated carbon has a hydrophilicity, determined as water vapor adsorption behavior, such that at a partial pressure p/p₀ of 0.6 not more than 25%, in particular not more than 20%, preferably not more than 10%, more preferably not more than 5%, of the maximum water vapor adsorption capacity of the activated carbon is exhausted and/or utilized, and/or wherein at a partial pressure p/p₀ of 0.6 not more than 25%, in particular not more than 20%, preferably not more than 10%, more preferably not more than 5%, of the maximum water vapor saturation loading of the activated carbon is reached.

61. The method as claimed in claim 59 or 60 wherein the activated carbon has a hydrophilicity, determined as water vapor adsorption behavior, such that at a partial pressure p/p₀ of 0.6 0.1% to 30%, in particular 0.5% to 25%, preferably 1% to 20%, more preferably 1.5% to 15%, yet more preferably 2% to 10%, of the maximum water vapor adsorption capacity of the activated carbon is exhausted and/or utilized, and/or wherein at a partial pressure p/p₀ 0.6 of 0.1% to 30%, in particular 0.5% to 25%, preferably 1% to 20%, more preferably 1.5% to 15%, yet more preferably 2% to 10%, of the maximum water vapor saturation loading of the activated carbon is reached.

62. A method of treating and/or cleaning a fluidic medium, preferably water, more preferably wastewater or tapwater, in particular for adsorptive removal of inorganically or organically, in particular organically, based impurities from the fluidic medium, in particular a method as claimed in any of claims 59 to 61,
comprising the step of utilizing an adsorptive filtering unit, in particular as defined in any of claims 39 to 52, comprising the step of endowing and/or equipping the filtering unit with at least one particulate adsorbent in the form of a spherical activated carbon,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores,
wherein the activated carbon has a fractal dimension of open porosity in the range of not more than 2.9 (i.e., ≦2.9), in particular not more than 2.89, preferably not more than 2.85, more preferably not more than 2.82, yet more preferably not more than 2.8, yet still more preferably not more than 2.75, yet even still more preferably not more than 2.7, and/or wherein the activated carbon has a fractal dimension of open porosity in the range from 2.2 to 2.9, in particular 2.2 to 2.89, preferably 2.25 to 2.85, more preferably 2.3 to 2.82, yet more preferably 2.35 to 2.8, yet still more preferably 2.4 to 2.75, yet even still more preferably 2.45 to 2.7 and
wherein the filtering unit, in particular the particulate adsorbent in the form of the spherical activated carbon, is brought into contact with a or the fluidic medium, preferably water, more preferably wastewater or tapwater, to be treated and/or cleaned.

63. The method as claimed in any of claims 59 to 62 wherein the activated carbon has an ash content of not more than 1 wt %, in particular not more than 0.95 wt %, preferably not more than 0.9 wt %, more preferably not more than 0.8 wt %, yet more preferably not more than 0.7 wt %, yet still more preferably not more than 0.5 wt %, yet even still more preferably not more than 0.3 wt %, most preferably not more than 0.2 wt %, determined as per ASTM D2866-94/04 and based on the activated carbon, and/or wherein the activated carbon has an ash content in the range from 0.005 wt % to 1 wt %, in particular 0.01 wt % to 0.95 wt %, preferably 0.02 wt % to 0.9 wt %, more preferably 0.03 wt % to 0.8 wt %, yet more preferably 0.04 wt % to 0.7 wt %, yet still more preferably 0.06 wt % to 0.5 wt %, yet even still more preferably 0.08 wt % to 0.3 wt %, most preferably 0.1 wt % to 0.2 wt %, determined as per ASTM D2866-94/04 and based on the activated carbon.

64. The method of using a particulate adsorbent in the form of a spherical activated carbon to extend the in-service and/or on-stream life, in particular to improve and/or increase the stability and/or resistance to biocontamination, of an adsorptive filtering unit, in particular as defined in any of claims 39 to 52,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached.

65. The method of using a particulate adsorbent in the form of a spherical activated carbon to treat and/or clean a fluidic medium, preferably water, more preferably wastewater or tapwater, in particular for adsorptive removal of inorganically or organically, in particular organically, based impurities,
wherein the activated carbon has a total pore volume, in particular a Gurvich total pore volume, in the range from 0.15 cm³/g to 3.95 cm³/g, wherein not less than 60% (i.e., ≧60%) of the total pore volume, in particular of the Gurvich total pore volume, of the activated carbon is formed by pores having pore diameters of not more than 50 nm (i.e., ≦50 nm), in particular by micro- and/or mesopores, and
wherein the activated carbon has a hydrophilicity, determined as water vapor adsorption behavior, such that at a partial pressure p/p₀ of 0.6 not more than 30% of the maximum water vapor adsorption capacity of the activated carbon is exhausted and/or utilized, and/or wherein at a partial pressure p/p₀ of 0.6 not more than 30% of the maximum water vapor saturation loading of the activated carbon is reached.

66. The method of using a filtering unit as claimed in any of claims 39 to 52 to treat and/or clean a fluidic medium, preferably water, more preferably wastewater or tapwater, in particular for adsorptive removal of inorganically or organically, in particular organically, based impurities from the fluidic medium.

67. The method of using a filtering unit as claimed in any of claims 39 to 52 for gas purification and/or gas regeneration.

68. The method of using a filtering unit as claimed in any of claims 39 to 52 for the removal of noxiants, in particular gaseous noxiants, or of toxic, harmful or environmentally damaging substances or gases.

69. The method of using a filtering unit as claimed in any of claims 39 to 52 to regenerate and/or provide cleanroom atmospheres, in particular for the electrical/electronics industry, in particular for semiconductor or chip manufacture.
